(19) United States
(12) Patent Application Publication
(10) Pub. No.: US 2025/0362537 A1
(43) Pub. Date: Nov. 27, 2025

(54) ELECTRONIC DEVICE

(71) Applicant: InnoLux Corporation, Miao-Li County (TW)

(72) Inventors: Yuan-Lin Wu, Miao-Li County (TW); Kuan-Feng Lee, Miao-Li County (TW); Yu-Chia Huang, Miao-Li County (TW)

(73) Assignee: InnoLux Corporation, Miao-Li County (TW)

(21) Appl. No.: 19/189,198

(22) Filed: Apr. 24, 2025

(30) Foreign Application Priority Data
May 24, 2024 (CN) 202410653146.X

(51) Int. Cl. G02F 1/1333; G02F 1/1335

(52) U.S. Cl. CPC G02F 1/13338; G02F 1/133514

(57) ABSTRACT

An electronic device including an identified pattern, a visible shielding structure, a first color unit, and a second color unit is provided. The identified pattern receives an invisible light. The visible light shielding structure is disposed on the identified pattern and includes a first portion overlapped with the identified pattern. The first color unit and the second color unit are overlapped with the first portion, in which a transmittance of the first color unit with respect to the invisible light is less than a transmittance of the second color unit with respect to the invisible light, and a first width of the first color unit is less than a second width of the second color unit.

### BACKGROUND OF THE DISCLOSURE

### 1. Field of the Disclosure

The present disclosure relates to an electronic device and particularly to an electronic device including an identified pattern used for position detection.

### 2. Description of the Prior Art

With the development of technology, electronic devices with touch sensing function have become increasingly popular. Although capacitive touch sensing technology has developed in the conventional electronic device to allow fingers to touch, its touch accuracy is still not as good as that of stylus. However, the conventional electronic device require an extra digital tablet to detect the input of the stylus, which increases the thickness and cost of the electronic device, and the inflexibility of the digital tablet further limits the application of the electronic device.

### SUMMARY OF THE DISCLOSURE

It is one of the objectives to provide an electronic device to reduce the thickness and cost of the electronic device or increase the application of the electronic device.

According to an embodiment of the present disclosure, an electronic device including a substrate, an identified pattern, a visible light shielding structure, a first color unit, and a second color unit is provided. The identified pattern is disposed on the substrate, wherein the identified pattern receives an invisible light. The visible light shielding structure is disposed on the identified pattern and includes a first portion overlapped with the identified pattern. The first color unit and the second color unit are disposed on the substrate and overlapped with the first portion, wherein a transmittance of the first color unit with respect to the invisible light is less than a transmittance of the second color unit with respect to the invisible light. In a cross section view, a first width of the first color unit is defined by the first color unit corresponding to the first portion, a second width of the second color unit is defined by the second color unit corresponding to the first portion, and the first width of the first color unit is less than the second width of the second color unit.

According to an embodiment of the present disclosure, an electronic device having a visible light shielding region is provided. The electronic device includes a substrate, an identified pattern, a first color unit, and a second color unit. The identified pattern is disposed on the substrate in a portion of the visible light shielding region, wherein the identified pattern receives an invisible light. The first color unit and the second color unit are disposed on the substrate, wherein a transmittance of the first color unit with respect to the invisible light is less than a transmittance of the second color unit with respect to the invisible light. In a cross section view, a first width of the first color unit is defined by the first color unit in the portion of the visible light shielding region, a second width of the identified pattern is defined by the identified pattern in the portion of the visible light shielding region, and the first width of the first color unit is less than the second width of the identified pattern.

According to an embodiment of the present disclosure, an electronic device including a substrate, sensing pattern, an identified pattern, a first insulating layer, and a light shielding structure is provided. The sensing pattern and the identified pattern are disposed on the substrate, wherein the identified pattern receives an invisible light. The first insulating layer is disposed on the sensing pattern and the identified pattern. The light shielding structure is disposed on the first insulating layer and includes a first portion overlapped with the identified pattern and a second portion overlapped with the sensing pattern.

In the electronic device of the present disclosure, since the identified patterns having the position information are provided, the electronic device may not require the extra digital tablet, thereby reducing the thickness and the cost of the electronic device, and/or improving the flexibility and application of the electronic device. Furthermore, by disposing the visible light shielding structure on the identified patterns to block the visible light and allow the invisible light to pass through, the signal-to-noise ratio of the identified patterns may be improved to raise the accuracy of the detected identified pattern.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating a cross section view of an electronic device according to a first embodiment of the present disclosure.

FIG. 2 is a schematic diagram illustrating transmittance spectra of the visible light shielding structure and different color units according to an embodiment of the present disclosure.

FIG. 3 is a schematic diagram illustrating a partial top view of an electronic device according to an embodiment of the present disclosure.

FIG. 4 is a schematic diagram illustrating a cross section view of an electronic device according to a variant embodiment of the first embodiment of the present disclosure.

FIG. 5 is a schematic diagram illustrating a cross section view of an electronic device according to another variant embodiment of the first embodiment of the present disclosure.

FIG. 6 is a schematic diagram illustrating a cross section view of an electronic device according to a second embodiment of the present disclosure.

FIG. 7 is a schematic diagram illustrating a cross section view of an electronic device according to a third embodiment of the present disclosure.

FIG. 8 is a schematic diagram illustrating a partial top view of an electronic device according to a fourth embodiment of the present disclosure.

FIG. 9 is a schematic diagram illustrating a cross section view of an electronic device according to a fifth embodiment of the present disclosure.

FIG. 10 is a schematic diagram illustrating a partial top view of an electronic device according to a sixth embodiment of the present disclosure.

FIG. 11 schematically illustrates a cross section view taken along a sectional line B-B′ and a section line C-C′ of FIG. 10.

FIG. 12 is a schematic diagram illustrating a cross section view of an electronic device in an unexpanded state and an expanded state according to a seventh embodiment of the present disclosure.

FIG. 13 is a schematic diagram illustrating the electronic device in a flat state according to the seventh embodiment of the present disclosure.

FIG. 14 is a schematic diagram illustrating a top view of an electronic device according to an eighth embodiment of the present disclosure.

FIG. 15 is a schematic diagram illustrating a top view of an electronic device according to a ninth embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function. In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected” includes means of direct or indirect electrical connection. Two elements electrically connected to each other may be in direct contact with each other to transfer electrical signals, and there is no other element between them. Alternatively, two elements electrically connected to each other may be bridged through another element between them to transfer electrical signals. The term “electrically connected” may also be referred to as “coupled”.

As disclosed herein, the terms “approximately”, “essentially”, “about”, or “substantially” generally mean within 20%, 10%, 5%, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

An electronic device of the present disclosure may, for example, include a display device, a sensing device, an antenna device, a touch device, a tiled device, or other suitable electronic devices, but not limited thereto. The electronic device of the present disclosure may be any kind of display device, such as a self-luminous display device or a non-self-luminous display device. The self-luminous display device may include light emitting diodes, light conversion layer, other suitable materials, or any combination thereof, but not limited thereto. The light emitting diode may, for example, include an organic light emitting diode (OLED), a mini light emitting diode (mini LED), a micro light emitting diode (micro LED), a quantum dot light emitting diode (e.g., QLED or QDLED), but not limited thereto. The light conversion layer may include wavelength conversion materials and/or light filtering materials. The light conversion layer may, for example, include a fluorescent material, a phosphor material, quantum dot (QD), other suitable materials or any combination of elements mentioned above, but not limited thereto. The non-self-luminous display device may include a liquid crystal display device, an electro-phoretic display device, or other suitable devices, but not limited thereto. The sensing device may, for example, be a sensing device used for detecting variation in capacitances, light, heat, or ultrasound, but not limited thereto. The sensing device may, for example, include a biosensor, a touch sensor, a fingerprint sensor, other suitable sensors, or any combination of sensors mentioned above. The antenna device may, for example, include liquid crystal antenna or antennas of other types, but not limited thereto. The tiled device may, for example, include a tiled display device or a tiled antenna device, but not limited thereto. Furthermore, the appearance of the electronic device may be, for example, rectangular, circular, polygonal, a shape with curved edges, curved or other suitable shapes. The electronic device may have peripheral systems such as a driving system, a control system, a light source system, a shelf system, etc. The electronic device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto. The electronic device of the present disclosure takes a display device having a touch sensing function as an example, but the present disclosure is not limited thereto.

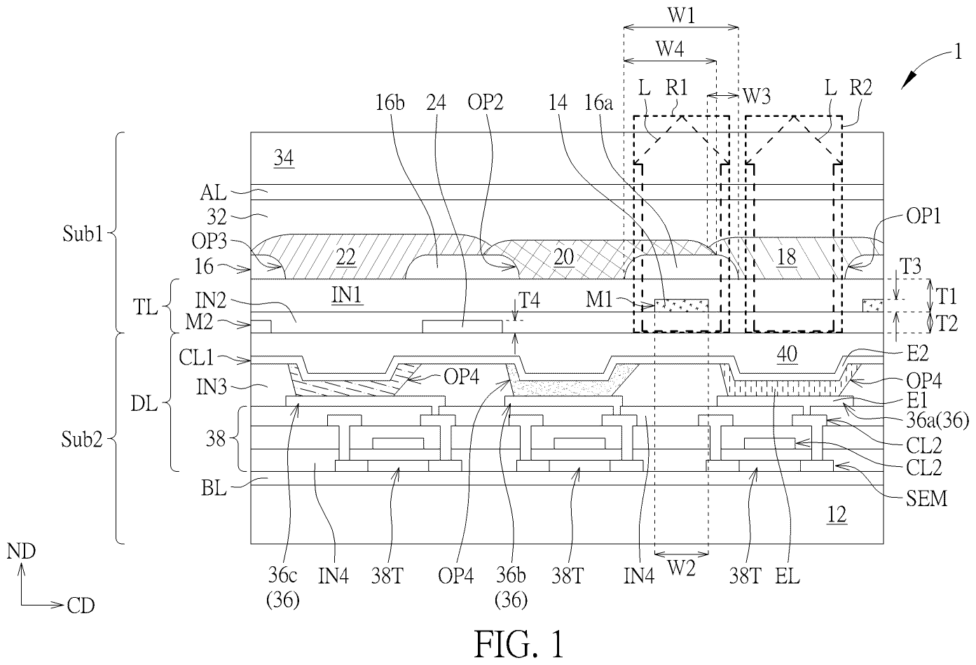

Refer to FIG. 1, which is a schematic diagram illustrating a cross section view of an electronic device according to a first embodiment of the present disclosure. As shown in FIG. 1, the electronic device 1 includes a substrate 12, an identified pattern 14, a visible light shielding structure 16, a color unit 18, and a color unit 20. The substrate 12 may be a flexible substrate that is able to be bent, folded, rolled, or stretched. The substrate 12 may, for example, include polyimide (PI), polyethylene terephthalate (PET), polycarbonate (PC), polyethersulfone (PES), polybutylene terephthalate (PBT), polyethylene naphthalate (PEN), polyarylester (PAR), other suitable materials, or any combination thereof. In some embodiments, the substrate 12 may be a rigid substrate, for example including glass, ceramic, quartz, sapphire, acrylic, or other suitable materials.

The identified pattern 14 is disposed on the substrate 12, wherein the identified pattern 14 may receive an invisible light. The visible light shielding disposed on the identified pattern 14, and the visible light shielding structure 16 includes a first portion 16a overlapped with the identified pattern 14. In the present disclosure, an element overlapped with another element may refer to that the element is completely or partially overlapped with the another element in a normal direction ND of the substrate 12. It is noted that in the present disclosure, the identified pattern 14 is able to be detected by a touch device capable of generating the invisible light. The touch device may be, for example, a stylus pen or other devices that are able to emit the invisible light. A position of the detected identified pattern 14 may be obtained/identified by recognizing the identified pattern 14, thereby determining the position of the touch device approaching or touching the electronic device 1. For example, the identified pattern 14 may be a pattern containing coordinate information or other types of position information, and the coordinate information of the identified pattern 14 in the electronic device 1 may be obtained by recognizing the identified pattern 14. The touch device of the present disclosure takes the stylus pen as an example, but not limited thereto.

In an embodiment, the number of the identified pattern 14 may be, for example, multiple, and the identified patterns 14 may be different from each other. For example, different identified patterns 14 may be different in shape, size, rotation angle, or other characteristics, so that the identified patterns 14 may correspond to information of different positions. Therefore, by embedding the information of positions corresponding to the identified patterns 14 in the touch device or a device electrically connected to the touch device, the touch device is capable of obtaining the information of corresponding position after recognizing the specific one of the identified patterns 14, thereby determining the position of the touch device approaching or touching the electronic device 1. In some embodiments, the number of identified patterns 14 may be at least one. In the present disclosure, when the identified patterns 14 is illuminated by the invisible light, the identified patterns 14 may absorb the invisible light and/or reflect the invisible light after receiving the invisible light. Each of the identified patterns 14 may, for example, include shielding material that is able to block the invisible light or an opening pattern that allows the invisible light to pass through, and the specific structure of the identified patterns 14 will be further described below.

The visible light shielding structure 16 has characteristics of shielding or blocking visible light and allowing the invisible light to pass through, so that the influence of ambient light on the detected signal of one of the identified patterns 14 may be reduced or avoided by overlapping the first portion 16a with the one of the identified patterns 14. Accordingly, the signal-to-noise ratio of the detected identified pattern 14 may be improved to increase accuracy of the detected identified pattern 14.

In the embodiment of FIG. 1, the visible light shielding structure 16 may be, for example, a black matrix. The visible light shielding structure 16 may have an opening OP1, an opening OP2, and an opening OP3, and the color unit 18 and the color unit 20 may be respectively disposed in the corresponding opening OP1 and the corresponding opening OP2. The visible light shielding structure 16 may include, for example, black organic material and/or black inorganic material. The organic material may include, for example, photoresist material, acrylic material, silicon-based material, epoxy-based material, other suitable materials, or any combination thereof, but not limited thereto. The acrylic material may be, for example, polymethyl methacrylate (PMMA), other suitable materials, or any combination thereof.

In some embodiments, in the cross section view, the width W1 of the first portion 16a of the visible light shielding structure 16 overlapped with one of the identified patterns 14 may be greater than the width W2 of the corresponding identified pattern 14, so that the corresponding identified pattern 14 is prevented from affecting the images displayed by the electronic device 1. The width W1 and the width W2 may be, for example, widths in a cross section direction CD. As disclosed herein, the cross section direction CD may refer to a direction perpendicular to the normal direction ND of the substrate 12. Also, a “width” of an element in a direction herein may refer to a maximum width of the element in the direction. For example, when the width of the first portion 16a in the cross section direction CD is not uniform, the width W1 of the first portion 16a may refer to the maximum width of the first portion 16a in the cross section direction CD. Similarly, the width W2 of the identified pattern 14 may refer to a maximum width of the identified pattern in the cross section direction CD.

The color unit 18 and the color unit 20 are disposed on the substrate 12 and are overlapped with the first portion 16a. In other words, the color unit 18 and the color unit 20 adjacent to the first portion 16a may extend onto the first portion 16a of the visible light shielding structure 16. In FIG. 1, the opening OP1 where the color unit 18 is disposed and the opening OP2 where the color unit 20 is disposed may be located on both sides of the first portion 16a, so that the first portion 16a may be located between the color unit 18 and the color unit 20.

In the embodiment of FIG. 1, the visible light shielding structure 16 may further include a second portion 16b separated from the first portion 16a, and the electronic device 1 may optionally further include a color unit 22 disposed on the substrate 12 and disposed in the opening OP3 of the visible light shielding structure 16. The color unit 20 and the color unit 22 may extend onto the second portion 16b of the visible light shielding structure 16 to be overlapped with the second portion 16b.

For example, the color unit 18, the color unit 20, and the color unit 22 may be green, red, and blue respectively to allow green light, red light, and blue light to pass through, but not limited thereto. In some embodiments, the color unit 18, the color unit 20, and the color unit 22 may be blue, red, and green respectively or blue, green, and red respectively, or may be other arrangements of red, blue, and green, respectively. In some embodiments, the color unit 18, the color unit 20, and the color unit 22 may not be limited to a combination of green, red, and blue, but may be three other different colors that are able to be mixed into white.

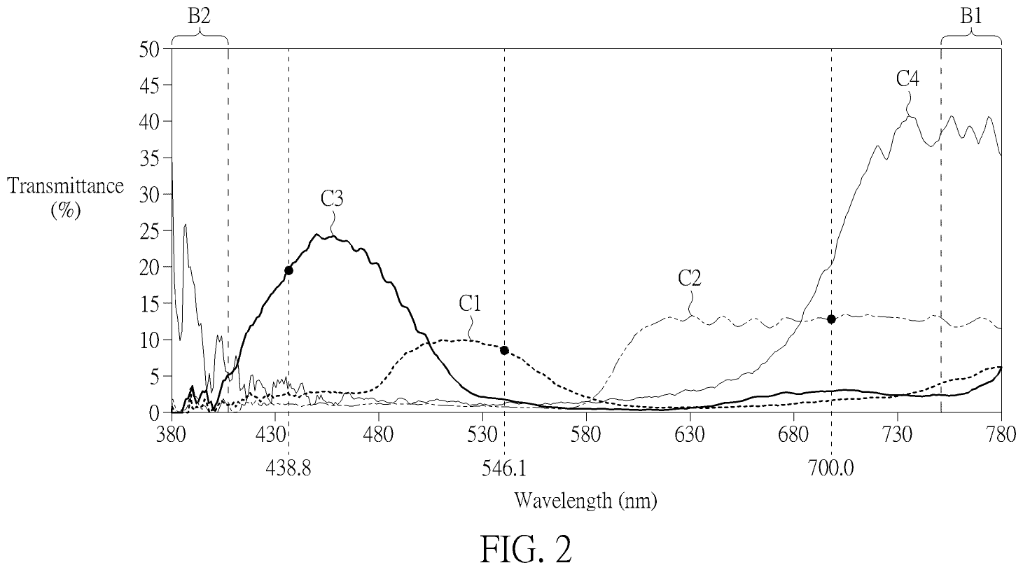

Refer to FIG. 2, which is a schematic diagram illustrating transmittance spectra of the visible light shielding structure and different color units according to an embodiment of the present disclosure. As shown in FIG. 1 and FIG. 2, in an example of the color unit 18, the color unit 20 and the color unit 22 being respectively green, red, and blue, the curve C1, the curve C2, and the curve C3 may be the transmittance spectra of the color unit 18, the color unit 20, and the color unit 22 respectively, and the curve C4 may be the transmittance spectrum of the visible light shielding structure 16. As can be seen from FIG. 2, the transmittance of the visible light shielding structure 16 with respect to the invisible light may be greater than the transmittance of one of the color unit 18, the color unit 20, and the color unit 22 with respect to the invisible light, so as to reduce the influence on the detection to the identified pattern 14, and one of the color unit 18, the color unit 20, and the color unit 22 may block the invisible light to reduce the influence of the ambient light on the detection to the identified pattern 14. For example, when the color unit 18, the color unit 20, and the color unit 22 are green, red, and blue respectively, the transmittance of the visible light shielding structure 16 with respect to the invisible light may be greater than the transmittance of the color unit 20 with respect to the invisible light; the transmittance of the color unit 20 with respect to the invisible light may be greater than the transmittance of the color unit 18 with respect to the invisible light; and the transmittance of the color unit 18 with respect to the invisible light may be greater than the transmittance of the color unit 22 with respect to the invisible light, but not limited thereto. The transmittance of the visible light shielding structure 16 with respect to the invisible light may be greater than 30%, for example. In some embodiments, the transmittance of the visible light shielding structure 16 with respect to the invisible light may be greater than the transmittance of the color unit 22 with respect to the invisible light and less than the transmittance of the color unit 20 and the transmittance of the color unit 18 with respect to the invisible light, or may be greater than the transmittance of the color unit 22 and the transmittance of the color unit 18 with respect to the invisible light and less than the transmittance of the color unit 20 with respect to the invisible light. In some embodiments, the transmittance of the visible light shielding structure 16 with respect to the invisible light may be greater than twice the transmittance of one of the color unit 18, the color unit 20, and the color unit 22 with respect to the invisible light. For example, the transmittance of the visible light shielding structure 16 with respect to the invisible light may be greater than twice the transmittance of the color unit 18, the color unit 20, or the color unit 22 with respect to the invisible light. In the present disclosure, the invisible light may be, for example, infrared light, ultraviolet light, or other invisible electromagnetic waves of other wavelength bands. The wavelength band B1 of the infrared light may, for example, range from 760 nanometers (nm) to 800 nm. The wavelength band B2 of the ultraviolet light may, for example, range from 380 nm to 400 nm.

It should be noted that a measuring method of the transmittance spectra of the visible light shielding structure 16, the color unit 18, the color unit 20, and the color unit 22 may be, for example, to measure the transmittance spectra of the individual visible light shielding structure 16, the individual color unit 18, the individual color unit 20, and the individual color unit 22 respectively, or to measure the transmittance spectra of portions of a composite layer structure (e.g., an upper board Sub1 in the following content) including the visible light shielding structure 16, the color unit 18, the color unit 20, and the color unit 22 respectively corresponding to the visible light shielding structure 16, the color unit 18, the color unit 20, and the color unit 22. The specific measuring method is detailed below.

Refer to FIG. 1 again. In the cross section view of the electronic device 1, the width W3 of the color unit 18 is defined by a portion of the color unit 18 corresponding to the first portion 16a, and the width W4 of the color unit 20 is defined by a portion of the color unit 20 corresponding to the first portion 16a, wherein the width W3 of the color unit 18 is less than the width W4 of the color unit 20. Since the transmittance of the color unit 18 is less than the transmittance of the color unit 20, the structure of the width W3 being less than the width W4 may reduce the blocking of the invisible light by the color unit 18, thereby improving the signal-to-noise ratio of the identified pattern 14. As disclosed herein, the portion of the color unit 18 (or the color unit 20) corresponding to the first portion 16a may refer to a portion of the color unit 18 (or the color unit 20) overlapped with the first portion 16a in the top view of the electronic device 1, and its width W3 (or width W4) may refer to a maximum width of the portion corresponding to the first portion 16a in the cross section direction CD. In other words, in the cross section view, the color unit 20 may be closer to the identified pattern 14 than the color unit 18. The comparing method of “close” mentioned here may, for example, be to compare overlapping areas of different color units and the identified pattern (e.g., the overlapping area of the color unit 20 is greater than the overlapping area of the color unit 18), or to compare distances between center lines of different color units and a center line of the identified pattern. In the present disclosure, the top view of the electronic device may be, for example, the electronic device viewed along a direction parallel to the normal direction ND of the substrate 12.

For example, as viewed from a top of the first portion 16a corresponding to identified pattern 14, when the transmittance of the color unit 20 is greater than that of the color unit 18, the overlapping area of the color unit 20 and the first portion 16a may be greater than that of the color unit 18 and the first portion 16a.

In the embodiment of FIG. 1, in the top view, the color unit 18 may be outside of the identified pattern 14, and the color unit 20 may be overlapped with the identified pattern 14, but not limited thereto. As disclosed herein, an element “outside of” another element in the top view may refer to that the element is not overlapped with the another element in the top view. In some embodiments, the color unit 18 and the color unit 20 may or may not be overlapped with the identified pattern 14.

As shown in FIG. 1, when the second portion 16b is not overlapped with the identified pattern 14, the transmittance of the color unit 22 may be less than the transmittance of the color unit 20, and the width of a portion of the color unit 20 corresponding to the second portion 16b may be less than the width of a portion of the color unit 22 corresponding to the second portion 16b, so as to reduce the amount of the invisible light emitting toward elements below the second portion 16b. In other words, in the cross section view, the color unit 22 may be closer to the identified pattern 14 than the color unit 20, but not limited thereto. In some embodiments, when the second portion 16b is overlapped with the identified pattern 14, the transmittance of the color unit 20 may be less than the transmittance of the color unit 22, and the width of the portion of the color unit 20 corresponding to the second portion 16b may be less than the width of the portion of the color unit 22 corresponding to the second portion 16b.

In FIG. 1, the portion of the color unit 18 and the portion of the color unit 20 overlapped with the first portion 16a may be overlapped with each other, and the portion of the color unit 20 and the portion of the color unit 22 overlapped with the second portion 16b may be overlapped with each other, but not limited thereto. In some embodiments, the portion of the color unit 18 and the portion of the color unit 20 overlapped with the first portion 16a may not be overlapped with each other, and/or the portion of the color unit 20 and the portion of the color unit 22 overlapped with the second portion 16b may not be overlapped with each other.

As shown in FIG. 1 and FIG. 2, since the color unit 18, the color unit 20, and the color unit 22 have different colors, one of the color unit 18, the color unit 20, and the color unit 22 may reduce or block light with the colors of other two of the color unit 18, the color unit 20, and the color unit 22 from passing through, thereby reducing influence of the ambient light on the contrast ratio of the images displayed by the electronic device 1. In other words, an anti-reflective effect may be achieved. The color unit 18, the color unit 20, and the color unit 22 may be, for example, color filters of different colors, which may include, for example, photoresist or other suitable light filtering materials.

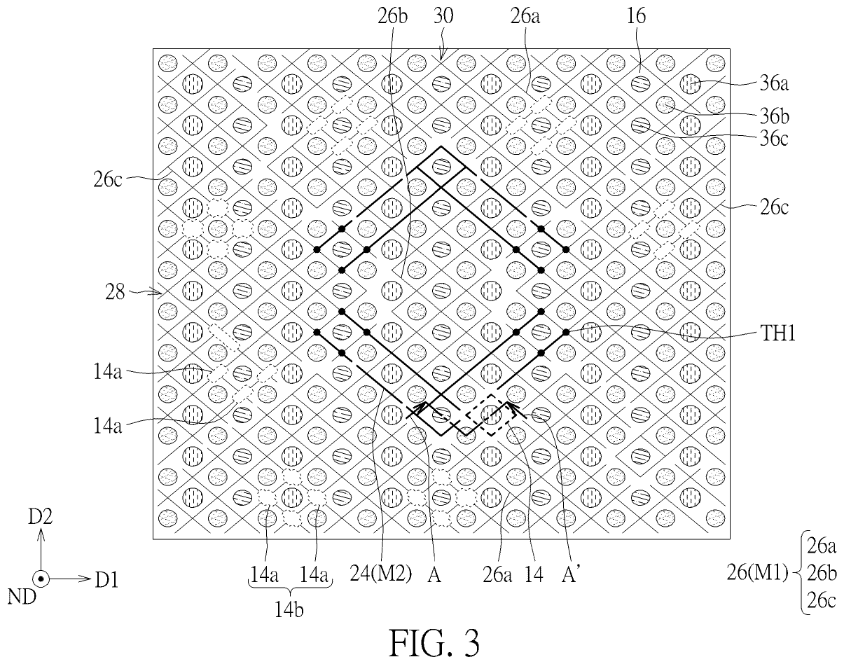

As shown in FIG. 1, the electronic device 1 may further include a sensing layer TL disposed between the visible light shielding structure 16 and the substrate 12, and the sensing layer TL may also be disposed between the color unit 18 and substrate 12, between the color unit 20 and substrates 12, and between the color unit 22 and substrate 12. The sensing layer TL may include at least one sensing pattern (e.g., a sensing pattern 26 shown in FIG. 3) to form a sensing element. In the embodiment of FIG. 1, the identified pattern 14 may be disposed in the sensing layer TL. For example, the sensing pattern and the identified pattern 14 may be formed of the same metal layer M1, but not limited thereto. The sensing layer TL may be used, for example, for touch sensing, biological face sensing, biological fingerprint sensing, blood oxygen sensing, distance sensing, electromagnetic wave sensing, or other suitable sensing applications. A touch sensing element may, for example, be used to detect the position of a touch object touching or approaching the electronic device 1. The touch object may include, for example, user's body part (e.g., a finger), a touch device, or other objects suitable for touch sensing. The following content takes the touch sensing element as an example, but not limited thereto.

In the embodiment of FIG. 1, the sensing layer TL may further include an insulating layer IN1 disposed on the sensing pattern and the identified pattern 14, and the visible light shielding structure 16 is disposed on the insulating layer IN1. It is noted that the insulating layer IN1 may separate the identified pattern 14 from the visible light shielding structure 16, so that the insulating layer IN1 may protect the identified pattern 14 to avoid damage to the identified pattern 14 during patterning the visible light shielding structure 16. For example, the thickness T1 of the insulating layer IN1 may be greater than the thickness T3 of the metal layer M1.

Refer to FIG. 3, which is a schematic diagram illustrating a partial top view of an electronic device according to an embodiment of the present disclosure, wherein FIG. 1 may be a schematic diagram illustrating a cross section view of FIG. 3 taken along a cross section line A-A′, but not limited thereto. As shown in FIG. 1 and FIG. 3, the sensing layer TL may further include an insulating layer IN2 and a plurality of sensing bridges 24 disposed between the sensing pattern 26 and the substrate 12, and the insulating layer IN2 is disposed between the sensing bridges 24 and the sensing pattern 26. The sensing bridges 24 may be formed of a metal layer M2, for example. The metal layer M1 and/or the metal layer M2 may, for example, include copper or other suitable materials. The insulating layer IN1 and/or the insulating layer IN2 may include, for example, silicon nitride, silicon oxide, silicon oxynitride or other suitable insulating materials.

In the embodiment of FIG. 3, the sensing pattern 26 may include, for example, a plurality of sensing pads 26a, a plurality of sensing bridges 26b and a plurality of sensing pads 26c, wherein the sensing bridges 24 may electrically connect the adjacent sensing pads 26c arranged in a first direction D1 to form a plurality of sensing strings 28, and the sensing bridges 26b may electrically connect adjacent sensing pads 26a arranged in a second direction D2 to form a plurality of sensing strings 30. In the top view, the sensing bridges 24 may be respectively overlapped with the sensing bridges 26b and be electrically insulated from the sensing bridges 26b, so that the sensing strings 28 may cross the sensing strings 30 to form the touch sensing element. In this embodiment, the sensing pads 26a may be directly connected to the sensing bridges 26b, and the sensing pads 26c may be electrically connected to the sensing bridges 24 through at least one through hole TH1, wherein the through hole TH1 may, for example, penetrate through the insulating layer IN2 shown in FIG. 1, but not limited thereto. The structure of the touch sensing element of the present disclosure is not limited to that shown in FIG. 3 and may be adjusted according to requirements. For example, the sensing bridges 24 may be formed of the metal layer M1, and the sensing pattern 26 may be formed of the metal layer M2.

In the top view, the sensing pattern 26 and the sensing bridges 24 may be overlapped with the visible light shielding structure 16, thereby reducing the visibility of the sensing pattern 26 and the sensing bridges 24, or avoiding affecting the displaying quality of the electronic device 1. For example, the sensing pattern 26 and the sensing bridges 24 may have a mesh structure, but not limited thereto. It should be noted that in order to clearly show the sensing bridges 24 and the sensing pattern 26, a width of a grid line used to represent the sensing bridge 24 is greater than a width of a grid line used to represent the sensing pattern 26 in FIG. 3, but the width of the sensing bridge 24 may actually be the same as or different from the width of the sensing pattern 26 according to the requirements and not limited to that shown in FIG. 3.

In some embodiments, the identified patterns 14 and the sensing bridges 24 may be formed of the same metal layer M2, or the identified patterns 14 may be formed of another suitable layer different from the sensing layer TL. In some embodiments, as shown in FIG. 3, one of the identified patterns 14a may be, for example, an opening pattern of the sensing pattern 26 to allow the invisible light to pass through, and the sensing pattern 26 may reflect the invisible light, so that the touch device may detect the identified pattern 14a. In some embodiments, the identified pattern 14b may be a combination of multiple identified patterns 14a, but not limited thereto. In some embodiments, the electronic device 1 may include the identified patterns 14 that are able to reflect the invisible light and/or include the identified patterns 14a and/or the identified pattern 14b that allows the invisible light to pass through. The identified patterns mentioned below takes the identified pattern 14 shown in FIG. 3 that is able to reflect the invisible light as an example, but the identified patterns 14a or the identified patterns 14b shown in FIG. 3 may be applied to any of the above or following embodiments.

As shown in FIG. 1 and FIG. 3, a thickness T1 of the insulating layer IN1 may be greater than a thickness T2 of the insulating layer IN2. In some embodiments, a thickness T3 of the metal layer M1 may be greater than a thickness T4 of the metal layer M2, so that the identified pattern 14 and the sensing pattern 26 may be bent or prevented from being damaged during the manufacturing process. In other words, the thickness T3 of one of the identified pattern 14 formed of the metal layer M1 may be greater than the thickness T4 of the sensing bridge 24 formed of the metal layer M2. For example, a ratio of the thickness T4 to the thickness T3 may be greater than or equal to 0.6 and less than 1 (i.e., 0.6≤the ratio of the thickness T4 to the thickness T3<1). In addition, the thickness T2 of the insulating layer IN2 may be greater than the thickness T4 of the metal layer M2. In some embodiments, when the identified pattern 14 and the sensing pattern 26 are formed of different metal layers, the thickness of the identified pattern 14 may be greater than the thickness of the sensing pattern, but not limited thereto.

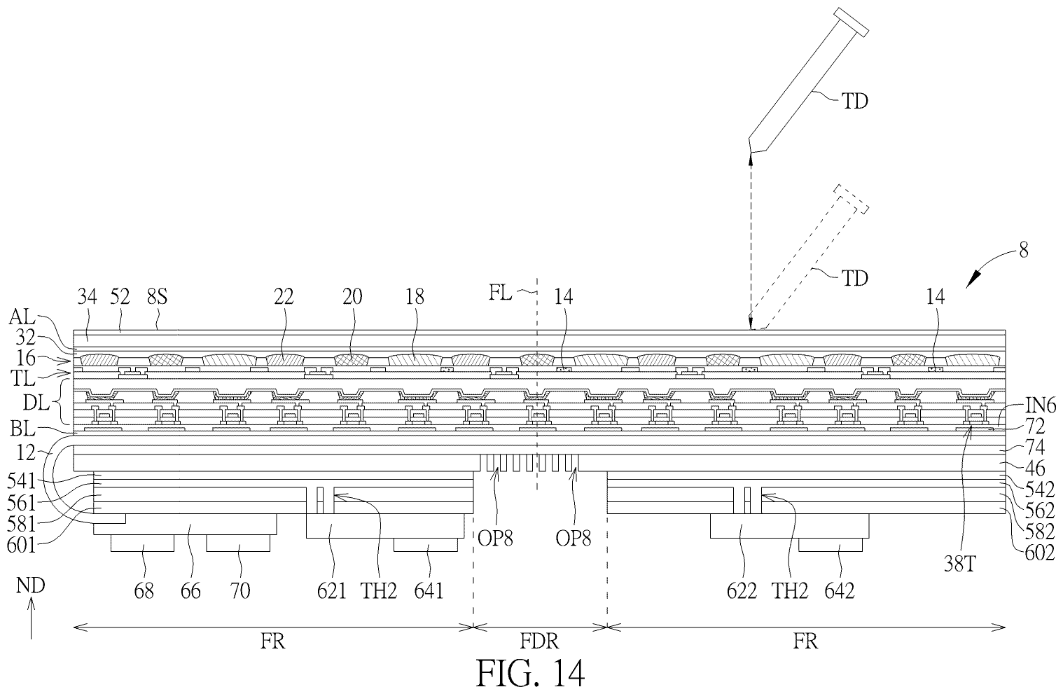

In the embodiment of FIG. 1, the electronic device 1 may further include a protecting layer 32 and a cover layer 34 sequentially disposed on the visible light shielding structure 16, the color unit 18, the color unit 20, and the color unit 22. The protecting layer 32 may be used to protect the visible light shielding structure 16, the color unit 18, the color unit 20, and the color unit 22. The protecting layer 32 may include organic material, such as photoresist material, PI, PET, adhesive or other suitable materials. The cover layer 34 may be attached to the protecting layer 32 through an adhesive layer AL. The cover layer 34 may include, for example, a combination of ultra-thin glass (UTG) and PET or other suitable materials. An upper surface of the cover layer 34 away from the protecting layer 32 may, for example, be used as an outer surface of the electronic device 1 for displaying images and/or for contacting the touch object. In some embodiments, a hard coating layer (e.g., a hard coating layer 52 shown in FIG. 14) may be optionally disposed on the cover layer 34. The hard coating layer may include, for example, PC, acrylic, or other suitable materials.

As shown in FIG. 1, the electronic device 1 may further include a display layer DL disposed between the substrate 12 and the sensing layer TL. The display layer DL may include light emitting elements, sensing elements, antennas and/or other suitable elements, so that the electronic device 1 may have displaying function, touch sensing function, and/or other suitable functions. In the embodiment of FIG. 1, the display layer DL may include a plurality of light emitting elements 36 and a circuit layer 38, wherein the light emitting elements 36 may be disposed between the substrate 12 and the sensing layer TL, and the circuit layer 38 may be disposed between the substrate 12 and the light emitting elements 36 and used to control the light emitting elements 36.

In FIG. 1, each of the light emitting elements 36 may include an organic light emitting diode (OLED), and may include an electrode E1, a light emitting layer EL, and an electrode E2 sequentially disposed on the circuit layer 38. For example, the display layer DL may further include an insulating layer IN3 disposed on the electrode E1, and the insulating layer IN3 has a plurality of openings OP4 respectively corresponding to the electrodes E1, wherein the light emitting layers EL may be respectively disposed in the corresponding openings OP4, and the electrodes E2 may be respectively disposed on the light emitting layers EL. In FIG. 1, the electrodes E2 may be connected to each other to form the same conductive layer CL1, but not limited thereto. The insulating layer IN3 may have a light shielding function to prevent light emitted from the light emitting element 36 from being mixed. The insulating layer IN3 may be called a pixel defining layer and may include organic material or inorganic material. The organic material may include, for example, PMMA, epoxy, siloxane material, silica gel material, other suitable materials, or any combination of the above materials. The inorganic material may include silicon nitride, silicon oxide, silicon oxynitride, liquid glass, glass glue, titanium oxide, aluminum oxide, other suitable materials or any combination of the above materials. The conductive layer CL1 may include transparent conductive material, such as indium tin oxide, thin metal, or other suitable materials. The electrode E1 may, for example, include metal.

In some embodiments, the light emitting elements 36 may not be limited to include the organic light emitting diodes, but may include mini-LED, micro-LED, quantum dots (QDs) materials, QLED, QDLED, nanowire LED, bar type LED, fluorescent material, phosphor material, other suitable materials or any combination of the above, but not limited thereto.

In the embodiment of FIG. 1, the light emitting elements 36 may include a first light emitting element 36a, a second light emitting element 36b, and a third light emitting element 36c respectively used to generate light of different colors, and the first light emitting element 36a, the second light emitting element 36b, and the third light emitting element 36c may respectively correspond to the color unit 18, the color unit 20, and the color unit 22. For example, the first light emitting element 36a, the second light emitting element 36b, and the third light emitting element 36c may be respectively used to generate light corresponding to the colors of the color unit 18, the color unit 20, and the color unit 22, such as green light, red light, and blue light, respectively. In the top view of the electronic device 1, the opening OP1, the opening OP2, and the opening OP3 may be overlapped with the first light emitting element 36a, the second light emitting element 36b, and the third light emitting element 36c respectively, but not limited thereto.

As shown in FIG. 3, in the top view, the first light emitting elements 36a, the second light emitting elements 36b, and the third light emitting elements 36c may be respectively disposed in grids of the mesh structures of the sensing pattern 26 and the sensing bridges 24, but not limited thereto. In this embodiment, the first light emitting elements 36a, the second light emitting elements 36b, and the third light emitting elements 36c may be arranged in an array, for example, and there may be one column of the second light emitting elements 36b disposed between each column of the first light emitting element 36a and each column of the third light emitting element 36c. In other words, the first light emitting elements 36a are not adjacent to the third light emitting elements 36c, but not limited thereto. The second light emitting elements 36b of each column may be staggered with the first light emitting elements 36a of each column and the third light emitting elements 36b of each column, but the arrangement of the light emitting elements 36 of the present disclosure is not limited thereto. In some embodiments, the arrangement of the first light emitting elements 36a, the second light emitting elements 36b, and the third light emitting elements 36c may be adjusted according to the requirements.

As shown in FIG. 1, the circuit layer 38 may include signal lines, insulating layers, active elements and/or passive elements. The active elements may include, for example, thin film transistors or other suitable transistors, but not limited thereto. The signal lines may include, for example, data lines, scan lines, common lines, or other required signal lines. In the embodiment of FIG. 1, the circuit layer 38 may include a plurality of transistors 38T, wherein the transistors 38T may be electrically connected to the corresponding light emitting elements 36 respectively and be used as driving elements and/or switching elements of the light emitting elements 36, but not limited thereto. The circuit layer 38 may include at least one semiconductor layer SEM, a multi-layer insulating layer IN4 and a multi-layer conductive layer CL2 to form the transistors 38T, the signal lines, wirings, capacitors, electrodes, and/or other circuit elements. In the embodiment of FIG. 1, the transistors 38T may be, for example, top-gate type thin film transistors, but not limited thereto. In some embodiments, the transistors 38T may be another type of thin film transistors, such as bottom-gate type thin film transistors.

As shown in FIG. 1, the display layer DL may further include a protecting layer 40 disposed between the light emitting elements 36 and the sensing layer TL to reduce the possibility of damage to the light emitting elements 36 by moisture or oxygen. The protecting layer 40 may, for example, include a stack of at least one inorganic material layer and at least one organic material layer or multiple inorganic material layers, but the present disclosure is not limited thereto. The inorganic material layer may, for example, include silicon nitride, silicon oxide, silicon oxynitride, aluminum oxide or other suitable protecting materials, or any combination of the above inorganic materials, but not limited thereto. Different inorganic material layers may include the same material or different materials. The organic material layer may have a function of flattening an upper surface thereof, and may, for example, include resin or other suitable materials.

In some embodiments, when the substrate 12 includes a flexible substrate, the electronic device 1 may optionally further include a buffer layer BL disposed between the substrate 12 and the circuit layer 38 to reduce the influence of moisture and/or oxygen on the circuit layer 38 and/or the light emitting layers EL. The buffer layer BL may, for example, include silicon nitride, silicon oxide, silicon oxynitride, or other suitable insulating materials.

It should be noted that when measuring the transmittance spectra of the visible light shielding structure 16, the color unit 18, the color unit 20, and the color unit 22, a part of layers of the electronic device 1 may be removed, and the composite layer structure part of the electronic device 1 may remain for measuring. In other words, the transmittances of the visible light shielding structure 16, the color unit 18, the color unit 20 and the color unit 22 mentioned herein may be, for example, transmittances of portions of the composite layer structure part corresponding to the visible light shielding structure 16, the color unit 18, the color unit 20, and the color unit 22, respectively. For example, the electronic device 1 may include an upper board Sub1 and a lower board Sub2, wherein the upper board Sub1 may include the sensing layer TL, the visible light shielding structure 16, the color unit 18, the color unit 20, the color unit 22, the protecting layer 32, the adhesive layer AL, and the cover layer 34, and the lower board Sub2 may include the display layer DL, the buffer layer BL, and the substrate 12. Furthermore, when the part of layers of the electronic device 1 is removed, the removed part of the electronic device 1 may be, for example, the lower board Sub2, and the remaining composite layer structure part may be, for example, the upper board Sub1, but not limited thereto. As shown in FIG. 1, the measuring method of the transmittance spectrum of the visible light shielding structure 16 may include irradiating light beam L from a side of the upper board Sub1 (e.g., a lower side of the upper board Sub1 shown in FIG. 1), aiming the light beam L at the position of a part of the upper board Sub1 where the visible light shielding structure 16 is overlapped with the identified pattern 14, and then measuring the intensity of the light beam L on the other side (e.g., an upper side of the upper board Sub1 shown in FIG. 1) and adjusting the wavelength of the light beam L to measuring the transmittance spectrum of the visible light shielding structure 16 in a specific wavelength band. The specific wavelength band may, for example, range from 380 nm to 780 nm as shown in FIG. 2. The spot size of the light beam L may be, for example, 10 μm multiplied by 10 μm. When measuring the transmittance spectrum of the visible light shielding structure 16, a region irradiated by the light beam L may be, for example, a region R1 of the upper board Sub1, which is overlapped with the first portion 16a. Similarly, the measuring method of the transmittance spectra of the color units may be similar to the measuring method of the transmittance spectrum of the visible light shielding structure 16. Taking the color unit 18 as an example, the light beam L may be aimed at the part of the upper board Sub1 corresponding to the color unit 18 to measure the transmittance spectrum of the color unit 18 in a specific wavelength band. When measuring the transmittance spectrum of the color unit 18, a region irradiated by the light beam L may be, for example, a region R2 of the upper board Sub1, which is overlapped with the color unit 18. The top view areas of the region R1 and the region R2 may be the same as each other. As can be seen from FIG. 1, since the region R1 and the region R2 of the upper board Sub1 include the same insulating layer IN1, the same insulating layer IN2, the same protecting layer 32, the same adhesive layer AL, and the same cover layer 34, the measured difference in transmittance between the region R1 and the region R2 may represent the difference in transmittance between the visible light shielding structure 16 and the color unit 18. The transmittance spectra of the color unit 20 and the color unit 22 may be obtained by the same method as the measuring method of the transmittance spectrum of the color unit 18, so they are not detailed again here. The transmittance spectrum shown in FIG. 2 may be, for example, the transmittance spectrum measured by irradiating the upper board Sub1. In some embodiments, in the top view, the width of a portion of the visible light shielding structure 16 that is able to be penetrated through by the invisible light may be greater than the maximum width of a portion of one of the color unit 18, the color unit 20, and the color unit 22 overlapped with the visible light shielding structure 16.

The electronic device of the present disclosure is not limited to the above embodiment, and may have other embodiments or variant embodiments. To simplify the description, the same reference numerals as those in the above embodiment will be used to label the same elements in the following other embodiments and variant embodiments. In order to clearly explain other embodiments and variant embodiments, the differences between other embodiments and the above embodiment and between variant embodiments and the above embodiment may be detailed below, and the repeated parts will not be described again.

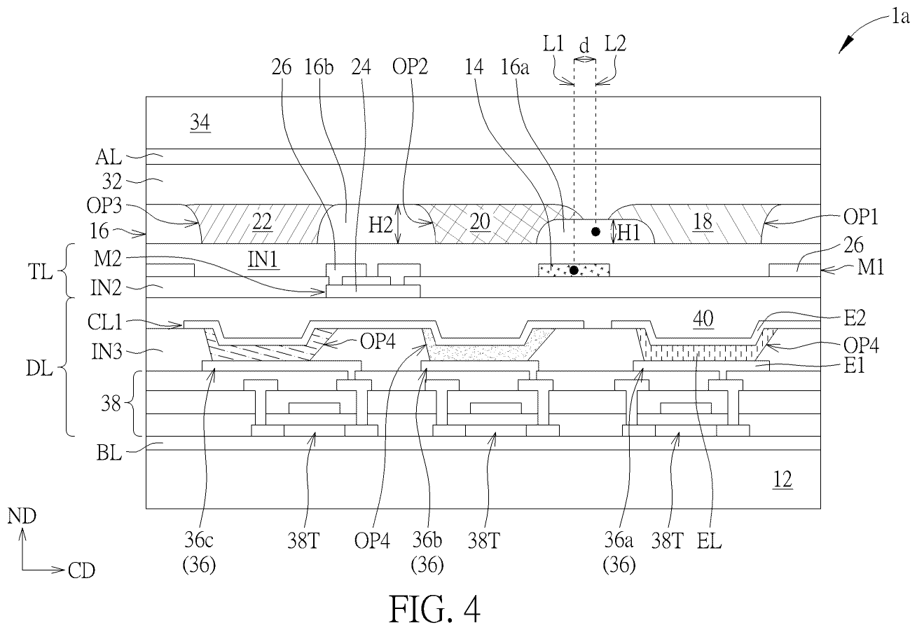

Refer to FIG. 4, which is a schematic diagram illustrating a cross section view of an electronic device according to a variant embodiment of the first embodiment of the present disclosure. As shown in FIG. 4, in the electronic device 1a provided by this variant embodiment, in the cross section view, a center line L1 of the identified pattern 14 and a center line L2 of the first portion 16a may be separated from each other and may not be aligned to each other, that is, a distance d between the center line L1 and the center line L2 in the cross section view may be greater than zero. The center line may, for example, be a straight line passing through a center point of an element and parallel to the normal direction ND. In other words, the identified pattern 14 may be closer to one of the color unit 18 and the color unit 20 in the top view and farther from the other one of them. When the transmittance of the color unit 18 with respect to the invisible light is less than the transmittance of the color unit 20 with respect to the invisible light, the identified pattern 14 may be closer to the color unit 20 with higher transmittance to improve the signal-to-noise ratio of the detected identified pattern 14. For example, the distance d may be less than or equal to half the width of the first portion 16a in the cross section direction CD.

In the embodiment of FIG. 4, the first portion 16a that is overlapped with the identified pattern 14 and the second portion 16b that is not overlapped with the identified pattern 14 have different thicknesses H1 and H2, respectively. The thickness H1 may be, for example, less than the thickness H2, so that the transmittance of the first portion 16a with respect to the invisible light may be greater than the transmittance of the second portion 16b with respect to the invisible light, thereby improving the signal-to-noise ratio of the identified pattern 14. In some embodiments, the difference between thickness H1 and thickness H2 may be used to any of the above or following embodiments.

In some embodiments, the color unit 18 and the color unit 20 extending onto the first portion 16a may not be overlapped with each other, that is, a part of the first portion 16a may not be covered with the color unit 18 and the color unit 20, so that the influence of the color unit 18 and the color unit 20 on the intensity of the invisible light may be reduced, and the signal-to-noise ratio of the identified pattern 14 may be improved. Other parts of the electronic device 1a of this variant embodiment may be similar to or the same as the electronic device 1 of FIG. 1, so they are not detailed here.

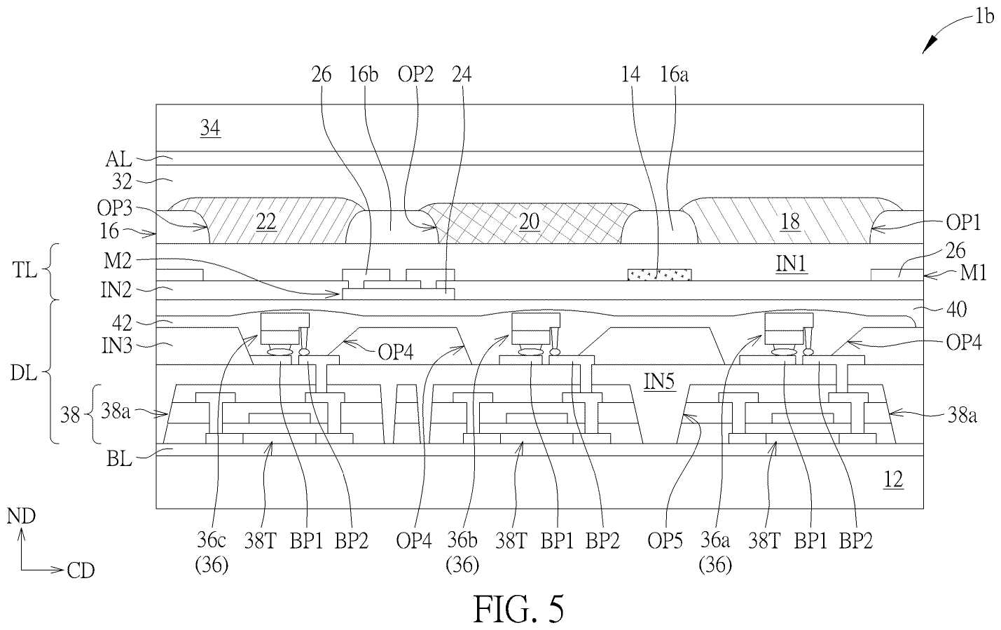

Refer to FIG. 5, which is a schematic diagram illustrating a cross section view of an electronic device according to another variant embodiment of the first embodiment of the present disclosure. As shown in FIG. 5, in the electronic device 1b provided in this variant embodiment, the light emitting elements 36 may include inorganic light emitting diodes. In this case, the display layer DL may include a plurality of pads BP1 and a plurality of pads BP2, and one of the openings OP4 of the insulating layer IN3 may correspond to one of the pads BP1 and one of the pads BP2, so that two pads of one of the light emitting elements 36 may be bonded to the corresponding pad BP1 and the corresponding pad BP2, respectively. In this variant embodiment, the identified pattern 14 may be located between the pad BP2 corresponding to one of the second light emitting elements 36b and the pad BP1 corresponding to one of the first light emitting elements 36a in the top view, but not limited thereto.

In the embodiment of FIG. 5, the display layer DL may optionally include an encapsulation layer 42 disposed on the light emitting elements 36 and the insulating layer IN3 and used to protect the light emitting elements 36. The encapsulation layer 42 may, for example, include encapsulating material or other suitable materials. In addition, the protecting layer 40 may be disposed on the encapsulation layer 42 to provide a flat upper surface to facilitate the formation of the sensing layer TL with high quality.

In the embodiment of FIG. 5, the circuit layer 38 may have a plurality of openings OP5, so that the circuit layer 38 may include a plurality of island structures 38a that are separated from each other. In this case, the display layer DL may further include an insulating layer IN5 disposed on the island structures 38a and disposed in the openings OP5 to improve the flexibility of the circuit layer 38. The openings OP5 may, for example, be not overlapped with the light emitting elements 36. In some embodiments, the insulating layer IN5 may, for example, include a single-layer structure or a multi-layer structure and may include any suitable organic material or inorganic material.

In this variant embodiment, the color unit 18 and the color unit 20 extending onto the first portion 16a may not be overlapped with each other, and the color unit 20 and the color unit 22 extending onto the second portion 16b may not be overlapped with each other, but not limited thereto. In some embodiments, the structure and relationship of the color unit 18, the color unit 20, and the color unit 22 in FIG. 5 may use any of the above or following embodiments. Other parts of the electronic device 1b of this variant embodiment may be the same as or similar to the electronic device 1 of FIG. 1, so they are not detailed here.

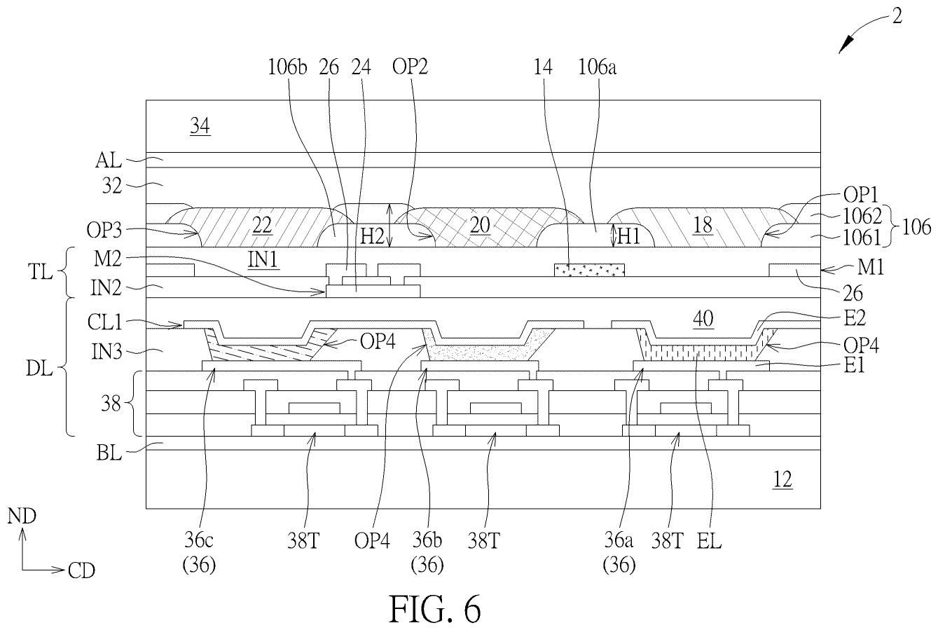

Refer to FIG. 6, which is a schematic diagram illustrating a cross section view of an electronic device according to a second embodiment of the present disclosure. As shown in FIG. 6, the electronic device 2 provided in this embodiment may include a light shielding structure 106, which replaces the visible light shielding structure 16 shown in FIG. 1. Specifically, the electronic device 2 of this embodiment may include the substrate 12, the sensing pattern 26, the identified pattern 14, the insulating layer IN2, and the light shielding structure 106, wherein the light shielding structure 106 is disposed on the insulating layer IN2, and the light shielding structure 106 includes a first portion 106a overlapped with the identified pattern 14 and a second portion 106b overlapped with the sensing pattern 26.

In the embodiment of FIG. 6, the light shielding structure 106 may be a multi-layer structure, and a quantity of layers of the first portion 106a may be different from a quantity of layers of the second portion 106b. For example, the quantity of layers of the first portion 106a may be less than the quantity of layers of the second portion 106b, and the thickness H1 of the first portion 106a may be less than the thickness H2 of the second portion 106b. For example, the light shielding structure 106 may include a first layer 1061 and a second layer 1062 sequentially disposed on the sensing layer TL, wherein a part of the first layer 1061 and a part of the second layer 1062 may form the second portion 106b, and the first portion 106a is formed of a part of the first layer 1061. In this embodiment, the transmittance of the first portion 106a with respect to the invisible light may be greater than 30%, for example. In one embodiment, both the first layer 1061 and the second layer 1062 may allow the invisible light to pass through and block the visible light from passing through. In this case, the structure that the quantity of layers of the second portion 106b is greater than the quantity of layers of the first portion 106a may help the second portion 106b shield the sensing pattern 26, or may help increase the intensity of the invisible light passing through the first portion 106a to improve the signal-to-noise ratio of identifying pattern 14. In some embodiments, when both the first layer 1061 and the second layer 1062 allow the invisible light to pass through and block the visible light from passing through, the quantity of layers of the first portion 106a may be the same as the quantity of layers of the second portion 106b, and for example, the first portion 106a may include a part of first layer 1061 and a part of second layer 1062. In addition, the light shielding structure 106 may, for example, include multiple layers of the visible light shielding structures of the above embodiment.

In another embodiment, the transmittance of the first layer 1061 of the first portion 106a with respect to the invisible light may be greater than the transmittance of the second layer 1062 of the second portion 106b with respect to the invisible light. For example, while the second layer 1062 may block the invisible light and the visible light, the first layer 1061 may allow the invisible light to pass through and blocks the visible light from passing through. In this circumstance, the ability of the second portion 106b to block the invisible light may be reduced to lower the possibility of irradiating the sensing pattern 26 by the invisible light and to improve the signal-to-noise ratio of the identified pattern 14. In this case, the first portion 106a may not have the second layer 1062. Other parts of the electronic device 2 of this embodiment may be the same as or similar to the electronic device of any of the above embodiments, so they are not described in detail here.

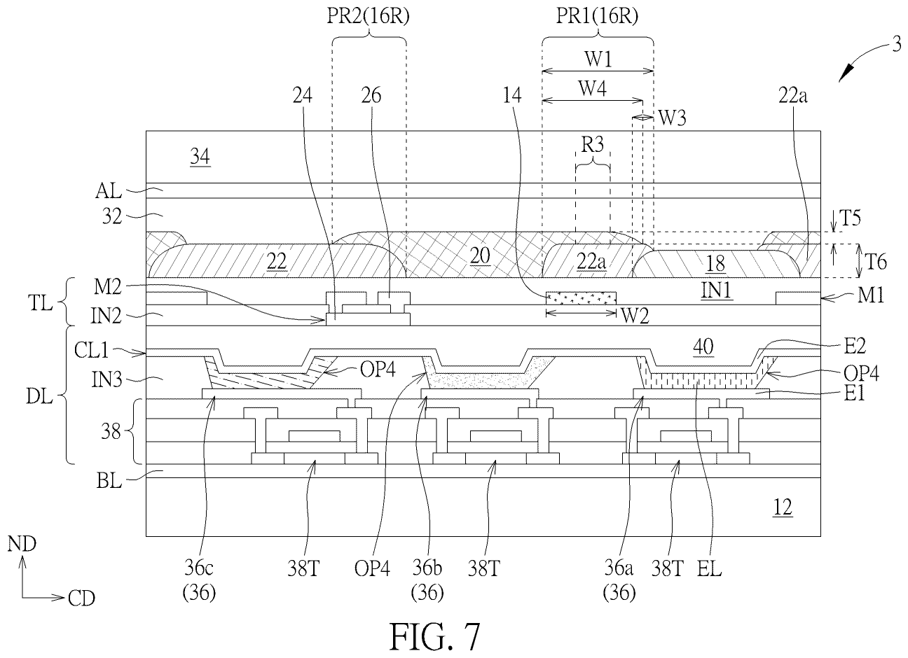

Refer to FIG. 7, which is a schematic diagram illustrating a cross section view of an electronic device according to a third embodiment of the present disclosure. As shown in FIG. 7, the electronic device 3 provided in this embodiment may have a visible light shielding region 16R, which replaces the visible light shielding structure 16 shown in FIG. 1. The visible light shielding region 16R may be defined, for example, by a stack of multiple visible light shielding structures or a stack of multiple color units. Specifically, the electronic device 3 may include the substrate 12, the identified pattern 14, the color unit 18, and the color unit 20, wherein the identified pattern 14 is disposed on the substrate 12 in a portion PR1 of the visible light shielding region 16R. In the embodiment of FIG. 7, the visible light shielding region 16R is described by taking the stacking of multiple color units as an example, but not limited thereto. The color unit 18 and the color unit 20 may be disposed on the substrate 12 in the visible light shielding region 16R. The transmittance of the color unit 18 with respect to the invisible light may be less than the transmittance of the color unit 20 with respect to the invisible light, and the width W3 of the color unit 18 is less than the width W4 of the color unit 20, wherein in the cross section view, the width W3 of the color unit 18 is defined by the color unit 18 in the portion PR1 of the visible light shielding region 16R, and the width W4 of the color unit 20 is defined by the color unit 20 located in the portion PR1 of the visible light shielding region 16R. In this embodiment, the width W1 of the visible light shielding region 16R may be greater than the width W2 of the identified pattern 14. Since the identified pattern 14 of this embodiment may be the same as or similar to the above embodiments, it is not detailed again here.

In the embodiment of FIG. 7, the identified pattern 14 may not be overlapped with the color unit 18 to reduce the influence of the color unit 18 with lower transmittance on the detection of the identified pattern 14. The electronic device 3 may further include a color unit 22a disposed on the substrate 12, wherein the color unit 18, the color unit 20, and the color unit 22a may have different colors, and at least a portion of the color unit 20 and at least a portion of the color unit 22a may be overlapped with each other in the portion PR1 of the visible light shielding region 16R. The portion PR1 may be defined, for example, by a stack of the color unit 22a and the color unit 20, but not limited thereto. In this embodiment, the colors of the color unit 18, the color unit 20, and the color unit 22a may be blue, green, and red respectively, but not limited thereto. In some embodiments, the color unit 22a may be replaced with the visible light shielding structure 16 of FIG. 1, FIG. 4 or FIG. 5 or the light shielding structure 106 of FIG. 6, but not limited thereto.

In some embodiments, the color unit 18 and the color unit 20 may be separated from each other in the portion PR1 of the visible light shielding region 16R. In some embodiments, the color unit 18 may or may not be overlapped with the color unit 20. In some embodiments, the color unit 18 may be disposed on the color unit 22a, that is, the color unit 22a is located between the color unit 18 and the substrate 12.

In some embodiments, a thickness T5 of at least a portion of the color unit 20 may be different from a thickness T6 of the at least a portion of the color unit 22a. For example, when the color unit 20 is green, and the color unit 22a is red, the thickness T5 may be less than the thickness T6, so as to enhance the intensity of the invisible light for detecting the identified pattern 14. In this content, the thicknesses of the color units may be obtained by measuring the thicknesses of the color units in a center region R3, wherein the center region R3 may, for example, be an overlapping region of the color units between a position at two thirds of the width of one of the color units (e.g., the color unit 22a) from a left edge of the color unit and another position at two thirds of the width of the color unit from a right edge of the color unit.

In the embodiment of FIG. 7, the electronic device 3 may further include the color unit 22 and the sensing pattern 26 disposed on the substrate 12, wherein the color unit 18, the color unit 20, and the color unit 22 have different colors. The sensing pattern 26 is disposed in another portion PR2 of the visible light shielding region 16R, and at least a portion of the color unit 20 and at least a portion of the color unit 22 may be overlapped with each other in the portion PR2 of the visible light shielding region 16R. The portion PR2 of the visible light shielding region 16R may be defined, for example, by the overlapping portion of the color unit 20 and the color unit 22. In FIG. 7, the color unit 20 may extend onto the color unit 22 in the portion PR2, but not limited thereto. In some embodiments, in the portion PR2, the color unit 20 may be disposed between the color unit 22 and the sensing layer TL. In some embodiments, the color unit 22a and the color unit 22 may have the same color or be formed of the same layer, but not limited thereto.

In some embodiments, the electronic device 3 may further include a color unit disposed in the portion PR2, and the color unit may, for example, have the same color as the color unit 18 or be formed of the same layer as the color unit 18. In this case, the color unit 18 may be disposed on the color unit 22a, and the transmittance of the color unit 18 may be greater than that of the color unit 20. Also, the identified pattern 14 may be overlapped with the color unit 18. For example, the color unit 18, the color unit 20, and the color unit 22 may be green, blue, and red, respectively, but not limited thereto.

In some embodiments, the identified pattern 14 may be disposed on the substrate 12 in the portion PR2 of the visible light shielding region 16R. In this case, the color unit 20 and the color unit 22 may be, for example, green and red or red and green, respectively. Furthermore, most of the color unit 18 located in the portion PR1 may be optionally overlapped with the color unit 20. For example, the width W3 of the color unit 18 may be close to or the same as the width W4 of the color unit 20, but not limited thereto. In some embodiments, the identified pattern 14 may not be overlapped with the color unit 18 or not be disposed in the portion PR1.

In some embodiments, a total thickness of a stack of a portion of the color unit 20 and a portion of the color unit 22 located on the identified pattern 14 may be less than a total thickness of a stack of a portion of the color unit 18, a portion of the color unit 22a, and a portion of the color unit 20 located on the sensing pattern 26. Other parts of the electronic device 3 of this embodiment may be the same as or similar to the electronic device of any of the above embodiments, so they are not detailed again here.

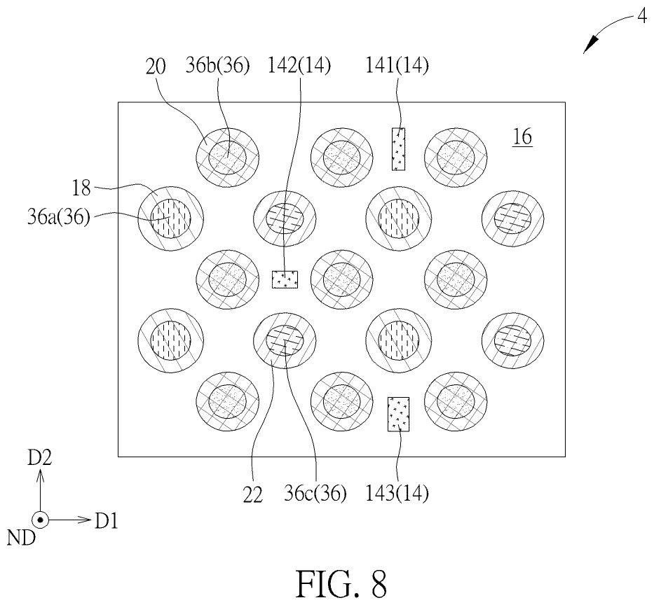

Refer to FIG. 8, which is a schematic diagram illustrating a partial top view of an electronic device according to a fourth embodiment of the present disclosure. In order to clearly illustrate the identified pattern 14, FIG. 8 shows the light emitting elements 36, the corresponding color units, the identified patterns 14, and the visible light shielding pattern 16, and omits other elements, but not limited thereto. As shown in FIG. 8, the identified patterns 14 of the electronic device 4 provided in this embodiment may include an identified pattern 141, an identified pattern 142, and an identified pattern 143 having different sizes. For example, top view shapes of the identified pattern 141, the identified pattern 142, and the identified pattern 143 may be rectangular, and widths of the identified pattern 141, the identified pattern 142, and the identified pattern 143 in the first direction D1 or the second direction D2 are different from each other. Alternatively, the widths of the identified pattern 141, the identified pattern 142, and the identified pattern 143 in the first direction D1 are different, and the widths of the identified pattern 141, the identified pattern 142, and the identified pattern 143 in the second direction D2 are also different. In some embodiments, the identified patterns 14 may have different shapes or rotating angles (or orientations).

In the embodiment of FIG. 8, the color unit 18, the color unit 20, and the color unit 22 may not be overlapped with each other, and the identified pattern 141, the identified pattern 142, and the identified pattern 143 may not be overlapped with the color unit 18, the color unit 20, and the color unit 22. In some embodiments, the widths of the identified pattern 141, the identified pattern 142, and the identified pattern 143 in one direction (e.g., the first direction D1 or the second direction D2) may be less than the width of the visible light shielding structure 16 in the direction.

In some embodiments, when the color unit 20 is green, and the color unit 22 is red, the color unit 20 and the color unit 22 may be overlapped with each other in the visible light shielding region using the embodiment of FIG. 7, and in this case, The electronic device may not include the visible light shielding structure, but not limited thereto.

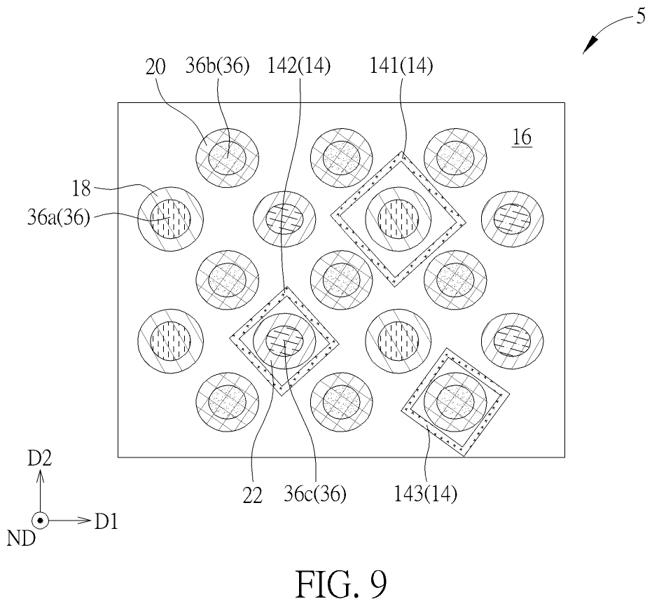

Refer to FIG. 9, which is a schematic diagram illustrating a cross section view of an electronic device according to a fifth embodiment of the present disclosure. In order to clearly illustrating the identified pattern 14, FIG. 9 shows the light emitting elements 36, the corresponding color units, the identified patterns 14, and the visible light shielding pattern 16, and omits other elements, but not limited thereto. As shown in FIG. 9, one of the identified patterns 14 of the electronic device 5 provided in this embodiment may surround at least one of the light emitting elements 36 in the top view. For example, the identified patterns 14 may include the identified pattern 141, the identified pattern 142, and the identified pattern 143 having different rotating angles (or orientations). For example, the top view shapes of the identified pattern 141, the identified pattern 142, and the identified pattern 143 may be a rectangle ring, and a side of the identified pattern 141, a side of the identified pattern 142, and a side of the identified pattern 143 may not be parallel or perpendicular to each other, but not limited thereto. In some embodiments, the identified pattern 141, the identified pattern 142, and the identified pattern 143 may have different sizes.

In some embodiments, when the color unit 20 is green, and the color unit 22 is red, the color unit 20 and the color unit 22 may be overlapped with each other in the visible light shielding region using the embodiment of FIG. 7, and in this case, the electronic device may not include the visible light shielding structure, but not limited thereto.

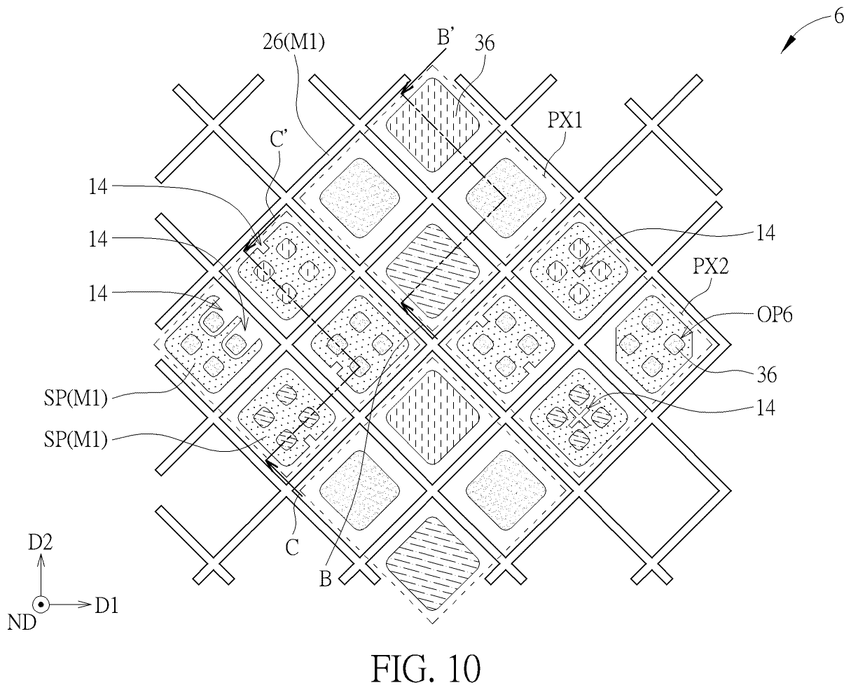

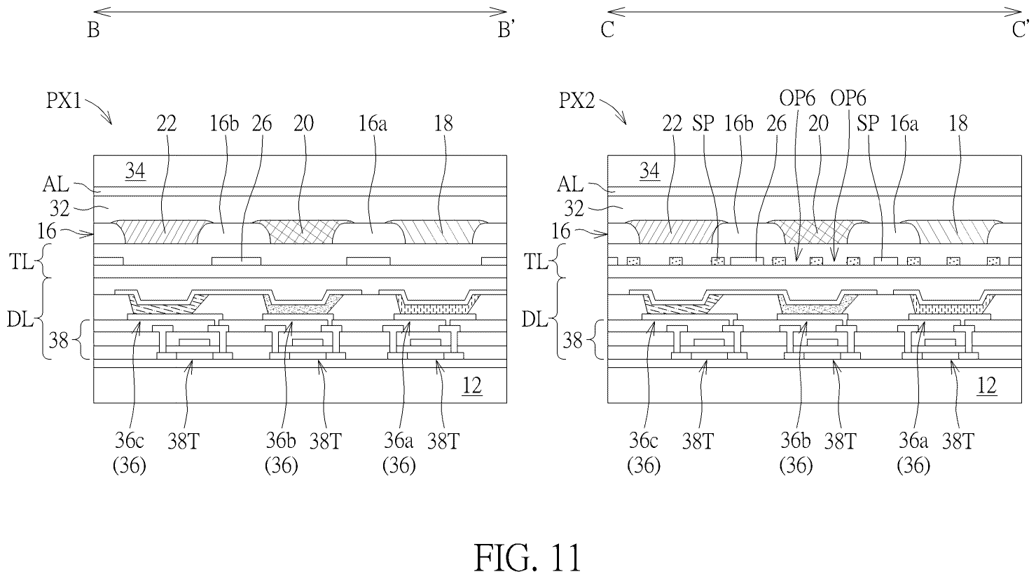

Refer to FIG. 10 and FIG. 11. FIG. 10 is a schematic diagram illustrating a partial top view of an electronic device according to a sixth embodiment of the present disclosure, and FIG. 11 schematically illustrates a cross section view taken along a sectional line B-B′ and a section line C-C′ of FIG. 10. As shown in FIG. 10 and FIG. 11, the electronic device 6 provided in this embodiment differs from the electronic device 1 in FIG. 1 in that the electronic device 6 may further include at least one light shielding pattern SP disposed on at least one of the light emitting elements 36. In the embodiment of FIG. 10, the number of the light shielding patterns SP may be multiple, and one of the light shielding patterns SP may, for example, correspond to one of the light emitting elements 36. One of the light shielding patterns SP may have at least one opening OP6, which allows the light from the corresponding light emitting element 36 to pass through. It is noted that since each of the light shielding patterns SP may be partially overlapped with the corresponding light emitting element 36 in the top view, light with a large emitting angle generated from the corresponding light emitting element 36 may be blocked to reduce viewing angle of images displayed by the light emitting elements 36 corresponding to the light shielding patterns SP, thereby achieving the effect of narrow viewing angle. The light shielding patterns SP may be formed of the same metal layer M1 as the sensing pattern 26, for example.

In the embodiment of FIG. 10, the number of the openings OP6 of one of the light shielding patterns SP may be multiple, and the openings OP6 may be overlapped with the corresponding light emitting element 36, but not limited thereto. In some embodiments, one of the light shielding patterns SP may have one opening OP6 corresponding to one of the light emitting elements 36.

It should be noted that the light shielding patterns SP may include the identified patterns 14, so that the identified patterns 14 may be integrated into the light shielding patterns SP to save the thickness of the electronic device 6. For example, the identified patterns 14 may include notches, openings, chamfers, bevels or other suitable microstructures of the light shielding patterns SP. The notches of different identified patterns 14 may, for example, face different directions. The number of notches of different identified patterns 14 may, for example, be different. In some embodiments, the light shielding patterns SP may include multiple identified patterns 14, and each of the identified patterns 14 may correspond to one of the light emitting elements 36. For example, the notches of different identified patterns 14 may be overlapped with one of the light emitting elements 36 respectively. In some embodiments, the openings of different identified patterns 14 may have different shapes, such as rectangles, crosses, or other suitable shapes. Alternatively, the chamfers of different identified patterns 14 may, for example, correspond to different sides of the light shielding patterns SP. The changes of the identified patterns 14 of the present disclosure are not limited to the mentioned above. The identified patterns 14 may not be overlapped with the light emitting elements 36 in the top view.

Furthermore, in the embodiment of FIG. 10 and FIG. 11, the electronic device 6 may, for example, include a plurality of first pixels PX1 and a plurality of second pixels PX2, and the second pixels PX2 may include the light shielding patterns SP, and the first pixels PX1 does not include the light shielding patterns SP. As shown in FIG. 10, each of the first pixels PX1 and the second pixels PX2 may include at least three light emitting elements 36 that generate different colors, so that the light emitting elements 36 of different colors may serve as sub-pixels respectively. In this case, by turning on the first pixels PX1 and turning off the second pixels PX2, the electronic device 6 may display images with wide viewing angle, and by turning on the second pixels PX2 and turning off the first pixels PX1, the electronic device 6 may display images with narrow viewing angle. In this embodiment, the first pixels PX1 and the second pixels PX2 may be arranged in a staggered formation, but not limited thereto.

In addition, as shown in FIG. 11, each of the first pixels PX1 and the second pixels PX2 may include a part of the circuit layer 38, a part of the display layer DL, a part of the sensing layer TL, the visible light shielding structure 16, the color unit 18, the color unit 20, the color unit 22, a part of the protecting layer 32, a part of the adhesive layer AL, and a part of the cover layer 34. In this embodiment, the color unit 18 and the color unit 20 disposed on the first portion 16a of the visible light shielding structure 16 may not be overlapped with each other, and the color unit 20 and the color unit 22 disposed on the second portion 16b of the visible light shielding structure 16 may not be overlapped with each other, but not limited thereto. In some embodiments, the light emitting elements 36, the visible light shielding structure 16, the color unit 18, the color unit 20, and the color unit 22 in FIG. 11 may use the structure of any of the above embodiments. Other parts of the electronic device 6 in FIG. 11 may be the same as or similar to any of the above embodiments and will not be described again here.

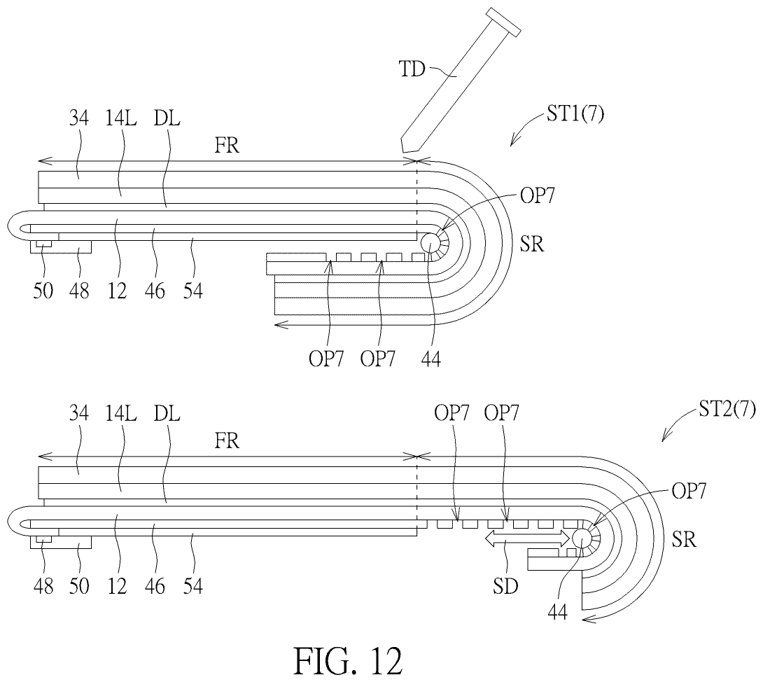

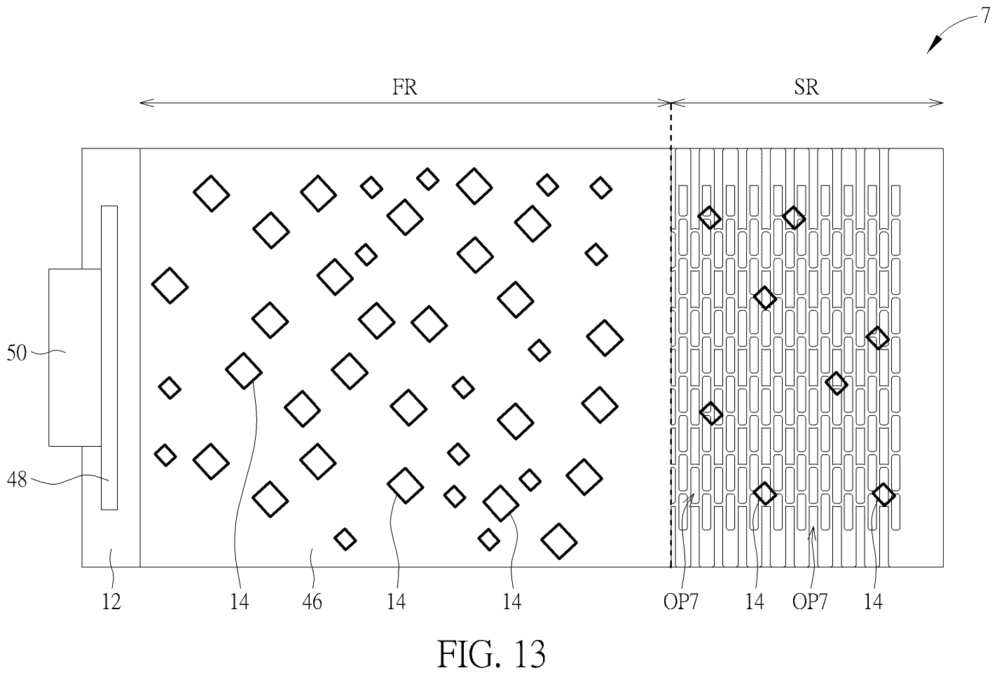

Refer to FIG. 12 and FIG. 13. FIG. 12 is a schematic diagram illustrating a cross section view of an electronic device in an unexpanded state and an expanded state according to a seventh embodiment of the present disclosure. FIG. 13 is a schematic diagram illustrating the electronic device in a flat state according to the seventh embodiment of the present disclosure. As shown in FIG. 12, the electronic device 7 provided in this embodiment may be, for example, a slidable display device, which is able to be expanded from an unexpanded state ST1 to an expanded state ST2, or be shrunk from the expanded state ST2 to the unexpanded state ST1. The electronic device 7 may have a flat region FR and a sliding region SR. When the electronic device 7 is in the unexpanded state ST1, a part of the sliding region SR may be disposed on the back side of the flat region FR of the electronic device 7. In this case, the width of the electronic device 7 in the sliding direction SD may be reduced, or the display area of the electronic device 7 may be reduced. When the electronic device 7 is in the expanded state ST2, another part of the sliding region SR may be extended to be on the same plane as the flat region FR, so as to display a part of image, thereby increasing the display area of the electronic device 7.

In the embodiment of FIG. 12, the electronic device 7 may include at least one mechanism 44 for adjusting the state of the electronic device 7 (unexpanded state ST1 or expanded state ST2). In some embodiments, the mechanism 44 may include, for example, a reel motor, roller, or other suitable mechanisms. In other embodiments (not shown), the electronic device 7 may adjust the state of the electronic device 7 manually or by other means.

In FIG. 12, the electronic device 7 may include the substrate 12, the display layer DL, an identified pattern layer 14L, and a cover layer 34. The display layer DL is disposed on the substrate 12. The identified pattern layer 14L is disposed on the display layer DL, and the cover layer 34 is provided on the identified pattern layer 14L. The identified pattern layer 14L may be, for example, the sensing layer TL of FIG. 1 and include a plurality of the identified patterns 14, but not limited thereto. The structure of the identified patterns 14 may use the identified patterns of any of the above embodiments and will not be described in detail here. The substrate 12, the display layer DL, the cover layer 34, and other parts of the electronic device 7 in FIG. 12 may use the electronic device of any of the above embodiments and will not be detailed again here.

In FIG. 12, the electronic device 7 may further include a support plate 46 disposed on a surface of the substrate 12 away from the display layer DL to provide sufficient support for the substrate 12, the display layer DL, and the identified pattern layer 14L. In this embodiment, a portion of the support plate 46 located in the sliding region SR may have a plurality of openings OP7 to facilitate the bending of the sliding region SR, while the portion of the support plate 46 located in the flat region FR does not have the openings.

In some embodiments, the electronic device 7 may further include at least one bonding pad 48 and a chip on film (COF) 50, wherein the bonding pad 48 may be located on the substrate 12 and disposed adjacent to a side of the flat region FR away from the sliding region SR, and the COF 50 is electrically connected with other elements of the electronic device 7 through the bonding pad 48, but not limited thereto.

In the embodiment of FIG. 12, the electronic device 7 may optionally further include a digital tablet 54 disposed in the flat region FR and located on a side of the support plate 46 away from the substrate 12. The digital tablet 54 may be used, for example, to more accurately detect the position where the touch device approaches or touches the electronic device 7. For example, the accuracy of the touch position detected by the digital tablet 54 may be higher than the accuracy of the identified patterns. The digital tablet 54 may, for example, use electromagnetic signals with an active or passive stylus or use other suitable methods to detect the position of the stylus.

As shown in FIG. 13, when the electronic device 7 includes the digital tablet 54, the distribution density of the identified patterns 14 in the flat region FR may be different from the distribution density of the identified patterns 14 in the sliding region SR. For example, the distribution density of the identified patterns 14 in the flat region FR may be greater than the distribution density of the identified patterns 14 in the sliding region SR to achieve the purpose of different requirements in touch accuracy between the flat region FR and the sliding region SR, but not limited thereto. In some embodiments, when the electronic device 7 includes the digital tablet 54 with high detection accuracy, the flat region FR of the electronic device 7 is able to detect the touch position through the digital tablet 54, such that the distribution density of the identified patterns 14 in the flat region FR may be less than the distribution density of the identified patterns 14 in the sliding region SR, or the flat region FR of the electronic device 7 may not include the identified patterns 14.

In some embodiments, the electronic device 7 may not include the digital tablet 54. In this case, the distribution density of the identified patterns 14 in the flat region FR may be greater than the distribution density of the identified patterns 14 in the sliding region SR, so that the touch accuracy of the touch device in the flat region FR for determining the touch position may be higher than that of the touch device in the sliding region SR, but not limited thereto.

Refer to FIG. 14, which is a schematic diagram illustrating a top view of an electronic device according to an eighth embodiment of the present disclosure. As shown in FIG. 14, the electronic device 8 provided in this embodiment may be, for example, a foldable device, and the electronic device 8 may have two flat regions FR and a foldable region FDR, wherein the foldable region FDR is disposed between the flat regions FR. Specifically, the electronic device 8 may further include a support plate 46 disposed on the surface of the substrate 12 away from the display layer DL to provide sufficient support for the substrate 12, the display layer DL, and the sensing layer TL, and the support plate 46 may include a plurality of openings OP8 disposed in the foldable region FDR, so that the flat regions FR of the electronic device 8 may be folded upward or downward along a folding axis FL, for example.

The substrate 12, the display layer DL, the sensing layer TL, the identified patterns 14, the visible light shielding structure 16, the color unit 18, the color unit 20, the color unit 22, the protecting layer 32, the adhesive layer AL, and the cover layer 34 of the electronic device 8 may use any one of the above embodiments and may refer to the above content, so they will not be described in detail here. It should be noted that in FIG. 14, the substrate 12, the display layer DL, the sensing layer TL, the identified patterns 14, the visible light shielding structure 16, the color unit 18, the color unit 20, the color unit 22, the protecting layer 32, the adhesive layer AL, and the cover layer 34 may be disposed in both the flat region FR and the foldable region FDR. Since the distribution range of the identified patterns 14 may cover the flat regions FR and the foldable region FDR, the touch device TD may detect the touch position in the flat regions FR and the foldable region FDR. In some embodiments, a hard coating layer 52 may be provided on the cover layer 34, but not limited thereto.

In some embodiments, as shown in FIG. 14, the electronic device 8 may optionally further include a digital tablet 541 and a digital tablet 542 respectively located under the support plate 46 in the corresponding flat regions FR. The electronic device 8 may optionally further include a heat dissipation plate 561 and a heat dissipation plate 562 located under the digital tablet 541 and the digital tablet 542 respectively. The electronic device 8 may optionally further include a back plate 581 and a back plate 582 located under the heat dissipation plate 561 and the heat dissipation plate 562 respectively. The digital tablet 541 and the digital tablet 542 may be, for example, the same as or similar to the digital tablet 54 in FIG. 12, so they are not described in detail here. The heat dissipation plate 561 and the heat dissipation plate 562 may be used to provide heat dissipation for the digital tablet 541 and the digital tablet 542 respectively, so as to reduce operating errors of the digital tablet 541 and the digital tablet 542 caused by overheating. Since the digital tablet 541, the digital tablet 542, the heat dissipation plate 561, the heat dissipation plate 562, the back plate 581, and the back plate 582 that are not flexible are not disposed in the foldable region FDR, it may facilitate the folding of the electronic device 8. It should be noted that the number of the identified patterns 14 overlapped with the digital tablet 541 and the digital tablet 542 may be greater than the number of the identified patterns 14 that are not overlapped with the digital tablet 541 and the digital tablet 542. Alternatively, the number of the identified patterns 14 in one of the flat regions FR may be greater than the number of identified patterns 14 in the foldable region FDR. Since the identified patterns 14 may be disposed in the foldable region FDR, in the top view, the distribution area of the identified patterns 14 may be greater than the total distribution area of the digital tablet 541 and the digital tablet 542.

In some embodiments, the electronic device 8 may further include a circuit board 621, a connector 641, a circuit layer 622 and a connector 642, wherein the digital tablet 541 and the digital tablet 542 located in different flat regions FR may be electrically connected to the circuit board 621 and the circuit board 622, respectively. The connector 641 may be disposed on the circuit board 621, and the connector 642 may be disposed on the circuit board 622, so that the digital tablet 541 and the digital tablet 542 may be electrically connected to other control elements through the circuit board 621, the circuit board 622, the connector 641, and the connector 642. In some embodiments, the heat dissipation plate 561 and the back plate 581 and/or the heat dissipation plate 562 and the back plate 582 may further have through holes TH2, such that the digital tablet 541 and the digital tablet 542 may be electrically connected the corresponding circuit board 621 and the circuit board 622 through the corresponding through holes TH2, respectively. In some embodiments, the electronic device 8 may not have the foldable region FDR and have a single flat region, so that the electronic device 8 is non-foldable, but not limited thereto. In this case, the support plate 46 may not include the opening OP8, and the electronic device may include a single digital tablet, a single heat dissipation plate, a single back plate, a single circuit board, and a single connector, so that the distribution area of the identified patterns 14 may be close to or the same as that of the digital tablets in the top view, but not limited thereto.

In some embodiments, the electronic device 8 may further include a circuit board 66, a control element 68, and a connector 70, wherein the control element 68 and the connector 70 are disposed on the circuit board 66, and the control element 68 may be electrically connected to or control elements in the display layer DL, such as the light emitting elements, transistors or other elements mentioned above, through the circuit board 66. The control element 68 or the elements in the display layer DL may be further electrically connected to external elements through the connector 70.

In some embodiments, the electronic device 8 may further include a plurality of light shielding patterns 72 respectively disposed under the corresponding transistors 38T and located between the substrate 12 and the transistors 38T. In FIG. 14, the light shielding patterns 72 may be disposed between the buffer layer BL and the transistors 38T, but not limited thereto. The light shielding patterns 72 may be used to reduce the influence of light emitted from the substrate 12 toward the transistors 38T on the transistors 38T. The light shielding patterns 72 may include, for example, light shielding material. When the light shielding patterns 72 include metal, an insulating layer IN6 may be further provided between the light shielding patterns 72 and the transistors 38T, but not limited thereto.

In some embodiments, the electronic device 8 may optionally further include a substrate 74 disposed between the support plate 46 and the substrate 12, but not limited thereto. The substrate 74 may be, for example, a composite substrate. The substrate 74 may include, for example, PI, PET or other suitable materials. Other parts of the electronic device 8 of this embodiment may use any of the above embodiments, so they will not be repeated here.

The method for detecting the touch position of the electronic device is further described below. As shown in FIG. 14, when the touch device TD has not yet touched an outer surface 8S of the electronic device 8 or is at a certain height from the outer surface 8S, the touch device TD may detect the identified patterns 14 through the invisible light, such that the position of the touch device TD corresponding to electronic device 8 may be identified. When it is determined that the touch device TD is located on the outer surface 8S of one of the flat regions FR of the electronic device 8, the digital tablet (e.g., the digital tablet 541 or the digital tablet 542) corresponding to the one of the flat regions FR may be activated. Accordingly, when the touch device TD touches the outer surface 8S, the digital tablet may detect the position of the touch device TD. Since the digital tablet 541 and the digital tablet 542 are in an off state before the position of the touch device TD is determined, the energy consumption of the digital tablet 541 and the tablet 542 may be saved, thereby saving the power.

In addition, when it is determined that the touch device TD is located on the outer surface 8S of a region of the electronic device 8 without the digital tablet 561 and the digital tablet 562, for example, on the outer surface 8S of the foldable region FDR of the electronic device 8, a touch sensing mode of the touch device TD may be activated to detect the position of the touch device TD through the touch sensing element of the electronic device 8, or to obtain the position of the touch device TD by a suitable algorithm. For example, the touch device TD may have capacitive touch function and be able to provide capacitance changes on the touch sensing element.

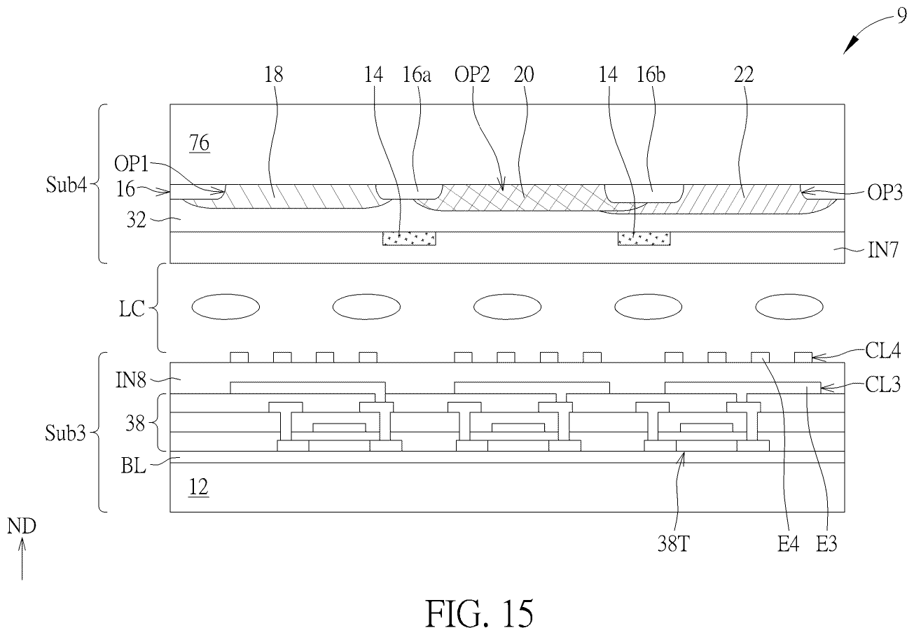

Refer to FIG. 15, which is a schematic diagram illustrating a top view of an electronic device according to a ninth embodiment of the present disclosure. As shown in FIG. 15, the electronic device 9 provided in this embodiment may be a non-self-luminous display device. A liquid crystal display panel is taken as an example of the electronic device 9 of this embodiment, which may include a circuit substrate Sub3, an opposite substrate Sub4, and a liquid crystal layer LC, wherein the liquid crystal layer LC is disposed between the circuit substrate Sub3 and the opposite substrate Sub4. The opposite substrate Sub4 may include a substrate 76, the visible light shielding structure 16, the color unit 18, the color unit 20, the color unit 22, the protecting layer 32, the identified patterns 14, and the insulating layer IN7, wherein the visible light shielding structure 16 may be disposed on a surface of the substrate 76 facing the substrate 76. The color unit 18, the color unit 20, and the color unit 22 may be respectively disposed in the opening OP1, the opening OP2, and the opening OP3 of the visible light shielding structure 16, and the protecting layer 32 is disposed on surfaces of the visible light shielding structure 16, the color unit 18, the color unit 20, and the color unit 22 facing the liquid crystal layer LC. The identified patterns 14 may be disposed on a surface of the protecting layer 32 facing the liquid crystal layer LC and be overlapped with the visible light shielding structure 16, and the insulating layer IN7 may be disposed on surfaces of the identified patterns 14 and the protecting layer 32 facing the liquid crystal layer LC. The substrate 76, the visible light shielding structure 16, and the protecting layer 32 of this embodiment may be the same as or similar to the cover layer 34, the visible light shielding structure 16, and the protecting layer 32 of any of the above embodiments, so they are not repeated here.

In one embodiment, the color unit 18 may not be overlapped with the color unit 20, and the portion of the color unit 20 overlapped with the first portion 16b of the visible light shielding structure 16 may be overlapped with the portion of the color unit 22 overlapped with the second portion 16b, but not limited thereto. In some embodiments, the color unit 18, the color unit 20, and the color unit 22 in FIG. 15 may use the structure of the color unit 18, the color unit 20, and the color unit 22 in any of the above embodiments. In the embodiment of FIG. 15, the opposite substrate Sub4 may not include the sensing layer, but not limited thereto.

In this embodiment, the circuit substrate Sub3 may include the substrate 12, the circuit layer 38, a conductive layer CL3, an insulating layer IN8, and a conductive layer CL4, wherein the conductive layer CL3 is disposed on the circuit layer 38. The insulating layer IN8 is disposed on the conductive layer CL3, and the conductive layer CL4 is disposed on the insulating layer IN8. The substrate 12 and the circuit layer 38 of this embodiment may be, for example, the same as or similar to the substrate 12 and the circuit layer 38 of any of the above embodiments, so they are not repeated here. The conductive layer CL3 may include a plurality of electrodes E3 electrically connected to the transistors 38T of the circuit layer 38, respectively. The conductive layer CL4 may include a plurality of electrodes E4, and each of the electrodes E4 may have a plurality of slits, such that a voltage difference between the electrode E3 and the electrode E4 may form a horizontal electric field to the liquid crystal layer LC. In other words, the liquid crystal display panel of FIG. 15 may be a fringe-field switching, FFS) liquid crystal display panel, but not limited thereto. In some embodiments, the liquid crystal display panel of FIG. 15 may be other types of liquid crystal display panels, such as in-plane switching type or vertical alignment type liquid crystal display panel. In some embodiments, the transistors 38T may not be overlapped with the opening OP1, the opening OP2, and the opening OP3 of the visible light shielding structure 16 to reduce the influence on the displaying quality. Other parts of the electronic device 9 of this embodiment may use any of the above embodiments, so they will not be repeated here.

In summary, in the electronic device of the present disclosure, since the identified patterns having the position information are provided, the electronic device may not require an extra digital tablet, thereby reducing the thickness and the cost of the electronic device, and/or improving the flexibility and application of the electronic device. Furthermore, by disposing the visible light shielding structure on the identified patterns to block the visible light and allow the invisible light to pass through, the signal-to-noise ratio of the identified patterns may be improved to raise the accuracy of the detected identified pattern.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
an identified pattern disposed on the substrate, wherein the identified pattern receives an invisible light;
a visible light shielding structure disposed on the identified pattern and comprising a first portion overlapped with the identified pattern; and
a first color unit and a second color unit disposed on the substrate and overlapped with the first portion, wherein a transmittance of the first color unit with respect to the invisible light is less than a transmittance of the second color unit with respect to the invisible light;
wherein in a cross section view, a first width of the first color unit is defined by the first color unit corresponding to the first portion, a second width of the second color unit is defined by the second color unit corresponding to the first portion, and the first width of the first color unit is less than the second width of the second color unit.

2. The electronic device of claim 1, wherein the first color unit is blue, and the second color unit is red.

3. The electronic device of claim 1, wherein the first color unit is green, and the second color unit is red.

4. The electronic device of claim 1, wherein the first portion is between the first color unit and the second color unit.

5. The electronic device of claim 4, wherein in the cross section view, the second color unit is closer to the identified pattern than the first color unit.

6. The electronic device of claim 5, wherein in a top view, the first color unit is outside of the identified pattern.

7. The electronic device of claim 1, wherein in the cross section view, a distance between a center line of the identified pattern and a center line of the first portion is greater than zero.

8. The electronic device of claim 1, wherein in the cross section view, a width of the identified pattern is less than a width of the first portion.

9. An electronic device having a visible light shielding region, comprising:
a substrate;
an identified pattern disposed on the substrate in a portion of the visible light shielding region, wherein the identified pattern receives an invisible light;
a first color unit and a second color unit disposed on the substrate, wherein a transmittance of the first color unit with respect to the invisible light is less than a transmittance of the second color unit with respect to the invisible light;
wherein in a cross section view, a first width of the first color unit is defined by the first color unit in the portion of the visible light shielding region, a second width of the second color unit is defined by the second color unit in the portion of the visible light shielding region, and the first width of the first color unit is less than the second width of the second color unit.

10. The electronic device of claim 9, further comprising a third color unit disposed on the substrate, wherein the first color unit, the second color unit, and the third color unit have different colors respectively, and at least a portion of the second color unit and at least a portion of the third color unit are overlapped in the portion of the visible light shielding region.

11. The electronic device of claim 10, wherein a thickness of the at least a portion of the second color unit is different from a thickness of the at least a portion of the third color unit.

12. The electronic device of claim 11, wherein the second color unit is green, the third color unit is red, and the thickness of the at least a portion of the second color unit is less than the thickness of the at least a portion of the third color unit.

13. The electronic device of claim 9, further comprising a third color unit and a sensing pattern disposed on the substrate, wherein the first color unit, the second color unit, and the third color unit have different colors respectively, the sensing pattern is disposed in an another portion of the visible light shielding region, at least a portion of the second color unit and at least a portion of the third color unit are overlapped in the another portion of the visible light shielding region, and the first color unit and the second color unit are separated in the portion of the visible light shielding region.

14. An electronic device, comprising:
a substrate;
a sensing pattern and an identified pattern disposed on the substrate, wherein the identified pattern receives an invisible light,
a first insulating layer disposed on the sensing pattern and the identified pattern; and
a light shielding structure disposed on the first insulating layer and comprising a first portion overlapped with the identified pattern and a second portion overlapped with the sensing pattern.

15. The electronic device of claim 14, wherein the light shielding structure is a multi-layer structure, and a quantity of layers of the first portion is different from a quantity of layers of the second portion.

16. The electronic device of claim 15, wherein a transmittance of a layer of the first portion with respect to the invisible light is greater than a transmittance of a layer of the second portion with respect to the invisible light.

17. The electronic device of claim 14, wherein a thickness of the first portion is less than a thickness of the second portion.

18. The electronic device of claim 14, wherein the invisible light is an infrared light, and a transmittance of the first portion with respect to the invisible light is greater than 30%.

19. The electronic device of claim 14, wherein a thickness of the identified pattern is greater than a thickness of the sensing pattern.

20. The electronic device of claim 14, further comprising a second insulating layer and a sensing bridge disposed between the sensing pattern and the substrate, wherein the second insulating layer is disposed between the sensing bridge and the sensing pattern, and a thickness of the first insulating layer is greater than a thickness of the second insulating layer.
